(19) United States
(12) Patent Application Publication
(10) Pub. No.: US 2005/0108038 A1
(43) Pub. Date: May 19, 2005

(54) Online fire plan system and method

(76) Inventors: Daryl Cober, Elora (CA); Stephen M. Fraser, Waterloo (CA); Michael Bowra, Stratford (CA)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/941,219

(22) Filed: Sep. 15, 2004

(30) Foreign Application Priority Data
Nov. 13, 2003 (CA) 2,449,151

(51) Int. Cl. G06F 17/60

(52) U.S. Cl. 705/1

(57) ABSTRACT

The online fire plan system includes a data entry, storage and retrieval module, and a fire plan wizard for guiding a user through the data entry, storage and retrieval. The data entry storage and retrieval module includes a web page layer, a business layer, and a data layer.

### FIELD OF THE INVENTION

The present invention relates generally to computer software application, and more particularly to an online application.

### BACKGROUND OF THE INVENTION

In the commercial and industrial building industry, legislation has regularly been enacted within fire codes to require buildings of certain occupancy types to have a “fire plan”. Many of these buildings are regulated by government to create, register and possess an emergency fire plan acceptable in content to local fire departments. A city with a population of 100,000 will typically have somewhere between 3,000 and 3,300 buildings of this type.

This is an onerous requirement imposed on building owners and managers. The government regulations are very broad in nature. Each fire department's requirements are usually specific to the locality. Each building is unique in construction and contents and poses additional enhancements to the required document.

While building owners can purchase template style documents that require a “fill in the blank” solution to creating a fire plan, these documents typically only cover the broad requirements and authors end up doing several re-writes to satisfy the local fire inspectors. This process is time consuming for both the author and fire inspector.

Often after an acceptable document is finally created and submitted to the local Fire Department, it is stored in the building never again to see the light of day. The author quite happily puts the experience behind him/her and never thinks about it again. If an emergency fire plan is to be a useful document it should be maintained and kept current. It should also be easily and readily accessible to fire department staff, building owners and their staff as well as building occupants.

Research has shown that most fire departments file these documents in large lockers, basement rooms, office closets, and the like. The filed documents are submitted in various shapes, sizes, colors, bindings, and the like, and are not conducive to easy filing, cataloging or sorting. As such, they are virtually useless to a fire department in real time emergency response environments.

A building owner is required to keep a copy on site. The fundamental problem here is that the only useable copy is likely inside the burning building. The intent of government regulations is to make the necessary information readily available to fire departments in response situations, fire inspectors for safety inspections, building owners to ensure compliance, and building occupants for informational instruction.

If all required buildings submitted a fire plan to the fire department one can readily see the difficulty of storing the plans, typically 30 to 60 pages each, at the department. While there is valuable information in a fire plan that could be used during an emergency response it is totally impractical to access this paper “mountain” on a timely basis.

Fire plans are generally submitted to a fire prevention officer (FPO) in numerous and disjointed formats, thus requiring the FPO to spend extra time reviewing and searching for relevant information. Fire plans are also required to be maintained and kept up to date. This unfortunately leads to further paper flow as individuals who do updates either fax or mail relevant updates to the fire department, thus generating additional filing and sorting time requirements. Research indicates that many fire departments do not even attempt to file updates.

The development of a commercial fire plan is not something that most building owners or managers will do more than once or twice in their life and it is, by nature, not a simple task. As a result, research has indicated that only about 50% to 60% of all buildings legislated to have a fire plan have actually done one. It is further estimated by fire officials at the local level that, of those plans that have been submitted, only 10% are up to date.

With regard to filing and particularly updating fire plans, there is no reliable database to provide good statistical information.

Emergency site information from the fire plan can provide increased safety to the firefighters. Unfortunately, depending on the municipality, this information is either not available, or only partially available to the responding fire team. Legislation dictates that the fire plan be available to the responding firefighters in “an accessible location”.

A number of larger municipal fire departments have recognized the numerous shortcomings of the existing system and have assumed that a software solution can be found or developed. This however has proven easier to say than to implement.

Typically, storage is only done at a main fire hall for the municipality. For a municipality population of 100,000, this will equate to a room of approximately 90 to 100 square feet lined with file cabinets. Plans are therefore typically unavailable to satellite fire halls.

The solution to this problem varies by fire department. Some print off drawings and store them in cabinets within responding fire trucks. This is proving problematic due to limited room in the trucks. Others attempt to do fire pre-plans developed by visits to commercial buildings. Again, the time to carry this out across a municipality, storage and retrieval issues, and keeping information up to date still is a problem.

Some fire departments have made word processing templates available for the development of a standard plan. This has had only partial success. The problem is that the user does not understand what information to submit, and lacks comfort with writing long reports. There has been no good practical solution that has been implemented by municipalities.

Some building owners will hire a consultant to develop their fire plan. Consultants however are loath to use any templates that may be provided by the local authority. Updating fire plans continues to be a major issue. Some municipalities attempt to use tax rolls and other municipal database info that may, or may not be available in that particular town to assess which buildings need a fire plan, and which ones have submitted a plan. Updates become an even more difficult clerical task to stay on top of.

Unfortunately, the only way at present to get good site information such as shut off locations, hazardous material storage and contact information and to hope that it is current, is to have the fire plan located on-site. Unfortunately, this location is likely where the fire is, and therefore inaccessible.

In an attempt to get around this, a few municipalities require a “lock-box” outside the building where the fire plan is stored. This has met with only partial success in some municipalities, and is simply not done in others.

Some large municipality fire departments have approached their regional IT (Information Technology) departments to develop a solution to some or all of the above problems. In several cases these IT departments have indicated that a solution like this should be simple, either using existing software off the shelf and/or developing a solution themselves. To date, there is no evidence of any municipality or private software consulting firm being able to develop a solution thus clearly indicating the complexity of the problem.

With the current system falling short of the intent of the government regulations, a new and easy to use interactive system that implements the sharing of useful data to all parties concerned is needed.

For the foregoing reasons, there is a need for an improved method and system for creating a fire plan.

### SUMMARY OF THE INVENTION

The present invention is directed to an online fire plan system and method. The system includes a data entry, storage and retrieval module and a fire plan wizard for guiding a user through the data entry, storage and retrieval. The data entry storage and retrieval module includes a web page layer, a business layer, and a data layer.

The method includes the steps of creating an online fire plan, and accessing the fire plan online.

Communities as well as property owners will experience improved levels of fire safety and awareness.

Because the system is convenient, it will encourage better rates of compliance with existing regulations.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

These and other features, aspects, and advantages of the present invention will become better understood with regard to the following description, appended claims, and accompanying drawings where:

FIG. 1 is an overview of an online fire plan system in accordance with an embodiment of the present invention;

FIG. 2 is an overview of an online fire plan method in accordance with an embodiment of the present invention;

FIG. 3 illustrates fire plan wizard starting information;

FIG. 4 illustrates a legal owner determination process flow;

FIG. 5 illustrates a building type process flow;

FIG. 6 illustrates a non-ambulatory process flow;

FIG. 7 illustrates a FPW status table;

FIG. 8 illustrates a user registration process flow;

FIG. 9 illustrates a payment process flow;

FIG. 10 illustrates a secondary user process flow;

FIG. 11 illustrates a house information page;

FIG. 12 illustrates an account table of a user's buildings;

FIG. 13 illustrates human resource data table;

FIG. 14 illustrates a building process flow;

FIG. 15 illustrates a legal owner table;

FIG. 16 illustrates an out building type table;

FIG. 17 illustrates an out building table;

FIG. 18 illustrates outbuilding table relationships;

FIG. 19 illustrates a web class process flow;

FIG. 20 illustrates a functional overview;

FIG. 21 illustrates a residential process flow;

FIG. 22 illustrates a commercial account application process flow;

FIG. 23 illustrates a commercial process flow;

FIG. 24 illustrates a residential site plan structure;

FIG. 25 illustrates a commercial site plan structure;

FIG. 26 illustrates a first section of a database schema;

FIG. 27 illustrates a second section of a database schema;

FIG. 28 illustrates a third section of a database schema; and

FIG. 29 illustrates a fourth section of a database schema.

### DETAILED DESCRIPTION OF THE PRESENTLY PREFERRED EMBODIMENT

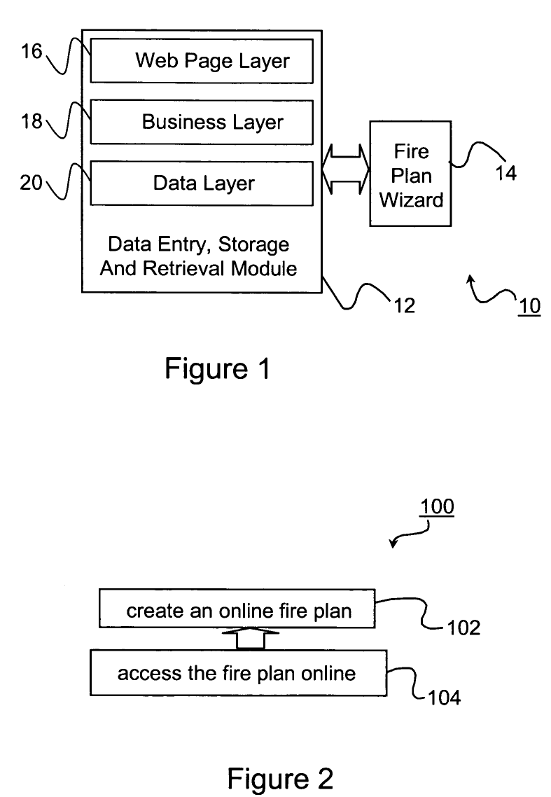

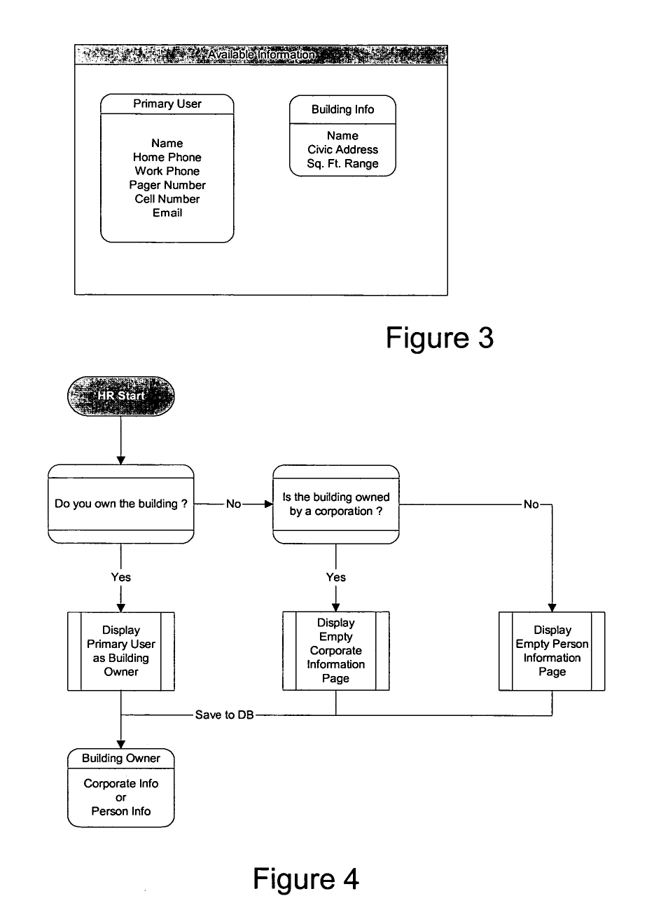

An embodiment of the present invention is directed to an online fire plan system and method. As illustrated in FIG. 1, the system 10 includes a data entry, storage and retrieval module 12 and a fire plan wizard 14 for guiding a user through the data entry, storage and retrieval. The data entry storage and retrieval module 12 includes a web page layer 16, a business layer 18, and a data layer 20.

As illustrated in FIG. 2, the method 100 includes the steps of creating an online fire plan 102, and accessing the fire plan online 104.

The system 10 is not a website in the traditional sense, but an online application that is accessed via the Internet.

The system 10 is a three-tiered application that is conceptually and physically different than a traditional website. The application is designed using three-tier system architecture having a virtual web page layer 16, a business layer 18, and a data layer 20.

The topmost layer is a virtual web page layer 16 that is a collection of web pages that equate to the normal website. These pages are the user interface or what the user sees. The difference is that the web pages are virtual and do not really exist as a single entity, and are instead generated by the second layer, or business layer 18.

The business layer 18 is written in a high level programming language and compiled into COM (Common Object Model) objects. The objects are responsible for enforcing business rules and customizing each and every page that the user sees based on information collected and stored in the application database.

The third layer is the data layer 20. Business objects do not save or maintain any data, and instead save and retrieve all data from the data layer 20. The data layer 20 includes a set of COM objects that can communicate with any large-scale database engine. By designing an interface like this, the application is capable of talking to any mainstream commercial database, thus allowing the application to participate in information sharing with other applications.

The system further includes a .pdf (Portable document format) file generator, an electronic mail generator, administrative interfaces, and a drawing package and the technology to print the drawing while the data still effectively resides on a server.

The system 10 provides an easy to use, online information conduit between the local community and the local Fire Department. An information highway of this type will help local communities by providing Fire Fighters with the most up to date information possible during the critical first moments of fire response that could mean the difference of saving the life of a loved one or family pet at the scene of a fire. It could also save the life of a firefighter by providing information about potential dangers at specific buildings during a response.

The system 10 includes a web site developed to expose a human interface for the system 10 engine, utilizing the Internet and common web browsers.

Implementing an interface using common web browsers lowers the technical barrier to entry for the general public to the lowest common denominator. In other words, the end user needs only to have a common computer, a web browser and an Internet connection to access the system 10.

The system 10 engine includes a data collection system, a validation and security system, and an email notification system.

The system 10 web site will allow the general public to enter information into the data collection system and then expose this information to local fire departments to be used for fire prevention purposes and emergency response teams at fire scenes.

The system 10 web site will provide commercial building owners the ability to enter data about their buildings and generate Fire Plans, both in printed format and electronic format, for each specific building. This information will also be exposed to the fire department to aid the building owner in compliance with fire code regulations. The email notification system will automatically send reminders to building owners to assist them in staying current with local testing and reporting compliance issues.

Application Design Criteria

Security

The system 10 will contain personal information and therefore will require security measures to be implemented.

The web site will expose general information to any web browser in an unsecured forum. The user will be required to register with system 10 to obtain a personal username and password to gain entry into the secured area of the web site. All data collection, retention and exposure will be contained within the secure area of the system.

The web site will implement SSL (Secure Sockets Layer) encryption to provide users with the highest level of security possible with today's available Internet encryption technology.

User passwords will be encrypted using an MD5 hash algorithm. MD5 encryption is an industry-accepted standard that only allows one-way encryption. That ensures the encrypted data cannot be reverse engineered to discover what the original information contains. This means that the only person who can possibly know the content of the encrypted data is the person who creates it.

The system 10 will not collect or store any credit card, debit card or bank information. Collection of revenues will be directed to a secure and reputable third party partner that specializes in electronic fund transactions. The end user can easily research these companies in order to provide the highest level of customer safety, satisfaction and comfort possible.

Technological Platforms

The system 10 comprises three platforms:
IIS Web Server
COM+ Component Server
SQL Data Server

These three platforms will all be hosted on servers.

IIS (Internet Information Server) delivers web pages to user's browsers based on user requests. IIS obtains data for these pages from COM+ Business Objects that in turn is responsible for accessing and storing information in the SQL data store.

Design Constraints

The web pages are a mixture of static and dynamic content. Each user will see the same type of page but obviously the page will contain information specific to the user who is requesting the page. Some pages may have different menu options and choices based on the users profile. Some pages may only be available under certain conditions. To achieve this level of flexibility the system 10 will utilizes IIS Application technology or web Class technology as it is commonly referred to.

The web class is a COM (Common Object Model) object that is constructed and compiled using Visual Basic. The web class object is hosted on the IIS server. It exposes an object interface through an ASP (Active Server Page) on the web server.

The user requests a web page from the web site via the Internet.

The requested ASP page on the IIS server launches a web class (COM Object). The Web Class can request data from the data store, process any user information, implement business rules and perform any other activities. The web class then parses a web template to obtain the basic code that will form the web page delivered back to the IIS server and ultimately back to the requesting browser. The COM object can replace special TAGS located in the code page to insert relevant data that relates to the requesting user.

The system 10 Web Site will expose interfaces for the following user types: Residential Home Owners, Commercial Building Owners, Fire Departments, and Fire Service Providers.

Each user type will be presented with a unique set of web pages to access the system and supply data relevant to the user type. Each user type will have unique process flows and system functionality.

The commercial building owner will be able to create and maintain multiple user accounts (Owner, Manager, Superintendent), pay for access online, renew his/her yearly subscriptions, create and maintain a list of buildings, enter and maintain select information about each building, generate a custom Fire Plan for each building, register each building with a local Fire Department, customize a list of automated email reminders for each building, view Fire Safety related information, maintain Fire Service related assets and service information for each building, view and print various reports for each building, and view and print summary reports for his/her account.

The Fire Department will be able to register online, create and maintain multiple user accounts, enter and maintain select information about the Fire Department, upload a graphic image to be included on specific user pages, view a list of registered buildings specific to Fire Department coverage area (District), define Area of Coverage (District), maintain a list of secondary Fire Departments who provide overlapping coverage, maintain a list of non-compliant buildings, email notices to individual building owners, upload/download and modify Master Word Documents for each section of the Fire Plan, generate an Asset Checklist (special name) for each registered building, send bulk email bulletins to registered buildings, set default reminder periods for various components of Commercial Fire Plan Assets, assign Fire Safety Officers to individual buildings (Work scheduling), view and print work schedules, view and print Asset Checklists (special name), view and print Building correspondence history, view and print various historical summary reports, and access building information to aid in emergency response.

The Fire Service Provider will be able to:
Register Online
Create and maintain multiple user accounts (Owner, Employees)
Pay for Access online
Renew his/her yearly subscriptions
Create and maintain a list of buildings
Enter and maintain select information about each building
Add service related data to each building
View and print service related reports
Assign buildings to employees (Work Scheduling)
View and print Work Schedules
View and print Asset Checklists
View and print Historical Building reports
View and print Historical Summary Reports

The user interface is entirely web based and split into the following sections:
Anonymous users/Unsecured Area
Registration/Payment Area
Residential User Pages
Commercial User Pages
Fire Department User Pages
Fire Service Provider User Pages

Web pages are constructed utilizing:
Standard HTML framework
CSS (Cascading Style Sheets)
Embedded JavaScript
Linked JavaScript Files

All pages continue a common graphical look and feel throughout the site. The user has to provide a Username and Password in order to gain access to the secured area of the web site. Web Classes are utilized to insert user specific data into the standard HTML template for each page. Pages are constructed to the lowest possible denominator in order to support as many web browsers as possible. However, at some point in time, it may be decided to support a specific platform only in order to implement browser specific functionality. If such a decision is made, a link will be provided on the Entry Page to enable the user to download and install the appropriate browser version.

The Anonymous Area of the site is unsecured and available to the casual web surfer. This area contains:
General Information about the site
Fee/Rates schedule
Registration Options
Log In Page
Reference and Information Library and Links
A Demonstration Version of the Product

The Registration Area of the site will be SSL (Secure Sockets Layer) encrypted. This means that any information submitted by a user will be encrypted to help ensure the user's security and safety. This area will contain:
Registration pages for each user type
Redirection to third party payment centers
Verification pages and instructions on how to log in

The Residential User Pages is SSL encrypted and reside behind the Log In page. This means that all access to these pages is restricted to users with valid usernames and passwords. The Log In process helps protect the user's privacy as well as allowing validation of the user to pre-determine his/her user type and to filter all information to his/her specific account. This area will contain:
Account Status/Renew Subscription
View/Edit Residence Information
Personal Fire Plan
Fire Department Registration
Customize Notifications

The Commercial User Pages will be SSL encrypted and reside behind the Log In page. This means that all access to these pages is restricted to users with valid usernames and passwords. The Log In process helps protect the user's privacy as well as allowing validation of the user to pre-determine his/her user type and to filter all information to his/her specific account. This area will contain:
Account Status/Renew Subscription
Add/Remove Buildings
View/Edit Building Information
Fire Plan Wizard to generate Fire Plans for each building
Fire Department Registration for each building
Customize Notifications for each building
View/Edit Fire Plans for each building
Add/Edit/Remove users for this account
View/Add Asset Service Information for each building
View/Print various Reports

This web-enabled software package allows companies and homeowners to complete detailed fire plans for their properties. The completed plans would be filed electronically with local fire departments for use during emergencies. Regular electronic updates of the plan would be quick and easy and fire service provider maintenance reports could be easily generated and retained. Communities as well as property owners experience improved levels of fire safety and awareness.

The system 10 creates a user friendly intuitive Internet web site available to users to assist them in gathering data, organizing it into a universal framework and generating complete and properly formatted Emergency Fire Plans both in electronic format and printed format that have been approved by local Fire Officials.

The web site will contain many extra features and functionality but the heart of the system will be the Universal Emergency Fire Plan Document. The purpose of this document is to define the contents and mechanics of the creation of this dynamic document.

Anatomical Overview

The Emergency Fire Plan Document can be a very simple document or a very complex document. Some deciding factors are:
Government legislation
Regional legislation
Local legislation
Local Fire Department requirements
Physical characteristics of the building
Human characteristics of the building

The endless combinations of the above can make for a confusing and onerous job of collecting information and preparation of adequate documents. A building owner can struggle with foreign terms and requirements only to be informed that his/her document is missing information and requires re-writes of various sections. Building owners and Fire Safety officials spend countless hours reviewing and editing the documents needed for compliance.

The system 10 reduces the most complex Emergency Fire Plan to several smaller defined sections that are easy to understand and complete. Utilizing a simple user interface that presents a series of easy to understand questions to gather information, process this data, formulate and present a series of data entry screens, the system will generate a complete and comprehensive Emergency Fire Plan for any building that will meet or exceed all existing legislative requirements.

By using templates that are specific to and updateable by local Fire Departments, the system 10 can ensure that all Fire Plans will be acceptable and complete in accordance with local regulations and requirements.

Framework

Several universal sections or components of the Emergency Fire Plan Document are identified:
Introduction
Building Resources
Human Resources
Emergency Procedures
Fire Extinguishment, Control or Confinement
Fire Hazards
Supervisory Staff and Related Duties
Training of Supervisory Staff
Fire Drills
Maintenance Procedures for Fire Protection Systems
Alternative Measures for Occupant Fire Safety
Fire Protection Measures
Schematics and Floor Plans
Non-Ambulatory Occupants

Each of the above identifies a Major Section of a completed Fire Plan. Some sections can be further reduced to sub sections or items that can be identified and formatted by asking the user a series of questions and or presenting the user with manageable data collection screens. Some items may be optional depending on the building structure and usage. The series of questions will help identify which items need to be included in each of the sections.

This methodology will allow the final document to be compact and will exclude sections of irrelevant “Boiler Plate” verbiage that is meaningless to the reader because it does not apply to the specific building.

Template

Each Section of the Fire Plan will consist of multiple textual documents or templates. The system 10 produces a standard series of documents that when combined will form the content of the Fire Plan. The system 10 will utilize the user's answers to questions and any relevant data entered about the building to determine the appropriate contents of each individual Fire Plan.

Each Fire Department will have access to the specific set of templates for their geographical area of jurisdiction. The system will allow the Fire Department to edit and update these templates so that any Fire Plan produced for buildings within their jurisdiction will contain the specific verbiage that they have created.

This ensures that every Fire Plan created by the system 10 will contain pre-approved content. The Fire Safety Official may now concentrate on Building requirements and compliance without the worry of actual content and wording of Fire Plans. The system 10 can reduce the compliance issue to the review of relevant data for the building. The Fire Safety Inspector will already know how the finished document will read.

The legislated Fire Regulations typically require that a copy of the Fire Plan be kept available within the building it covers. To comply, a printed hard copy is assembled and located somewhere inside the building. The purpose of this is two fold. First it ensures compliance. Secondly it provides a hard copy technical reference for building occupants and Emergency Response Personnel.

The legislative requirements often require a copy to also be filed with the Fire Department. The purpose is the same, compliance and a source of information.

The system 10 eliminates the need for a hard copy to be archived at the Fire Department. As each building is registered, compliance becomes a function of inspection.

The Fire Department will have access to more accurate and complete information using the online system than the previous printed hard copy archives. This information will be up to date and searchable. It will be displayed in a meaningful and useful format. It will be available 7/24 and the retrieval time will be seconds.

The benefits of such a system to the Fire Department are self-explanatory.

Building Types

The first criteria to be determined will be the type of building. A well-formatted fire plan for a residential apartment will be significantly different than one for a commercial plastics factory. The building code defines various building types as groups and divisions. The system 10 simplifies the building type to a short list of primary types, with a related secondary type to further define the building type.

Primary building types include residential, commercial, industrial, and institutional. Each primary type will be sub divided into specific secondary types as defined in Tables 1-4 as follows.

TABLE 1
Residential Buildings

| Residential | Group | Division |
|---|---|---|
| Apartment | C | 1 |
| Boarding House | C | 1 |
| Convent | C | 1 |
| Dormitory | C | 1 |
| Hotel | C | 1 |
| Lodging House | C | 1 |
| Monastery | C | 1 |
| Motel | C | 1 |
| Residential Club | C | 1 |
| Residential College | C | 1 |
| Residential House | C | 1 |
| Residential School | C | 1 |

TABLE 2
Commercial Buildings

| Commercial | Group | Division |
|---|---|---|
| Amusement Park Structure | A | 4 |
| Arena | A | 3 |
| Art Gallery | A | 2 |
| Auditorium | A | 2 |
| Bank | D | 1 |
| Barber Shop | D | 1 |
| Beauty Shop | D | 1 |
| Bleacher | A | 4 |
| Bowling Alley | A | 2 |
| Business Office | D | 1 |
| Church | A | 2 |
| Community Hall | A | 2 |
| Courtroom | A | 2 |
| Dance Hall | A | 2 |
| Department Store | E | 1 |
| Exhibition Hall | E | 1 |
| Grandstand | A | 4 |
| Gymnasium | A | 2 |
| Hairdressing Shop | D | 1 |
| Indoor Swimming Pool | A | 3 |
| Lecture Hall | A | 2 |
| Library | A | 2 |
| Licensed Beverage Establishment | A | 2 |
| Live Performance Theatre | A | 1 |
| Market | E | 1 |
| Medical Office | D | 1 |
| Motion Picture Theatre | A | 1 |
| Museum | A | 2 |
| Non Residential Club | A | 2 |
| Non Residential College | A | 2 |
| Non Residential School | A | 2 |
| Opera House | A | 1 |
| Passenger Station | A | 2 |
| Police Station without Detention | D | 1 |
| Radio Station | D | 1 |
| Recreational Exhibition Hall | A | 2 |
| Recreational Pier | A | 2 |
| Restaurant | A | 2 |
| Reviewing Stand | A | 4 |
| Rink | A | 3 |
| Self Serve Dry Cleaning using Non | D | 1 |
| Flammables | | |
| Self Serve Laundry | D | 1 |
| Shop | E | 1 |
| Small Tool and Appliance Rental | D | 1 |
| and Service | | |
| Stadium | A | 4 |
| Store | E | 1 |
| Supermarket | E | 1 |
| Television Studio with Audience | A | 1 |
| Undertaking Parlour | A | 2 |

TABLE 3
Industrial Buildings

| Industrial | Group | Division |
|---|---|---|
| Aircraft Hanger | F | 2 |
| Box Factory | F | 2 |
| Bulk Plant for Flammables | F | 1 |
| Bulk Storage for Hazardous | F | 1 |
| Candy Plant | F | 2 |
| Cereal Mill | F | 1 |
| Chemical Plant | F | 1 |
| Cold Storage Plant | F | 2 |
| Creamery | F | 3 |
| Distillery | F | 1 |
| Dry Cleaning Establishment using | F | 2 |
| Non Flammable | | |
| Dry Cleaning Plant | F | 1 |
| Electrical Substation | F | 2 |
| Factory | F | 2 |
| Feed Mill | F | 1 |
| Flour Mill | F | 1 |
| Freight Depot | F | 2 |
| Grain Elevator | F | 1 |
| Helicopter Roof Pad | F | 2 |
| Laboratory | F | 2 |
| Laboratory | F | 3 |
| Lacquer Factory | F | 1 |
| Laundry Service | F | 2 |
| Mattress Factory | F | 1 |
| Paint Factory | F | 1 |
| Parking Garage | F | 3 |
| Planing Mill | F | 2 |
| Power Plant | F | 3 |
| Printing Plant | F | 2 |
| Pyroxylin Factory | F | 1 |
| Repair Garage | F | 2 |
| Rubber Processing Plant | F | 1 |
| Salesroom | F | 2 |
| Sample Display Room | F | 3 |
| Spray Painting Operation | F | 1 |
| Storage Garage | F | 3 |
| Television Studio without Audience | F | 2 |
| Varnish Factory | F | 1 |
| Warehouse | F | 2 |
| Waste Paper Processing Plant | F | 1 |
| Wholesale Room | F | 2 |
| Woodworking Factory | F | 2 |
| Workshop | F | 2 |

TABLE 4
Institutional Building

| Institutional | Group | Division |
|---|---|---|
| Children Custodial Home | B | 2 |
| Convalescent Home | B | 2 |
| Hospital | B | 2 |
| Infermary | B | 2 |
| Jail | B | 1 |
| Nursing Home | B | 2 |
| Orphanage | B | 2 |
| Penitentiary | B | 1 |
| Police Station with Detention | B | 1 |
| Prison | B | 1 |
| Psychiatric Hospital | B | 2 |
| Psychiatric Hospital with Detention | B | 1 |
| Reformatory | B | 2 |
| Reformatory with Detention | B | 1 |
| Sanitarium | B | 2 |

Complex Groups

The scenario will arise when a residential building owner will register a town house or duplex. From an abstract point of view this is not a problem, however from a reactive or emergency point of view it becomes advantageous to know if the emergency condition will affect other families. While one cannot ensure that all owners will comply with registration, the system 10 considers those who do.

To achieve this type of information availability the system 10 introduces the concept of grouping registrations or buildings into a complex. This also works for a commercial situation where there is one municipal address but several detached buildings located in proximity to each other on a common site.

A residential scenario could be a six-plex row house. Six individual row houses contain a common roof and are individually owned by the residents. Typically this building has a common municipal address and each house has a unit number. Sometimes the system 10 has a Building Number and a Unit Number. As residents apply for accounts our software picks up the common municipal address and relates the information based on Unit Numbers and building numbers. If an emergency condition should arise at a municipal address that has related units the system 10 can then provide all information to the response team. This is a tremendous advantage in a response situation. The system 10 can also provide immediate notification to subscribers using an alarm response mechanism or service company.

Fire Plan Sections

Introduction

The introduction is a brief explanation of the requirements of the Fire Plan. It speaks of specific legislation; outlines compliance issues and indicates penalties and remedies for non-compliance. This section will be specific for Primary Building Types. This section will be required in all Fire Plans.

Building Resources

Building Resources is a large section that will contain all the specific data concerning the physical attributes of the building. To be manageable it should be broken down into sub components. Each sub component will have a set of qualifying criteria.

Some component criteria may include triggers that are specific to building type. The sub components are as follows:
Municipal Address
The municipal address is the physical address of the building.
Required in all Fire Plans.
   Fire Department
The primary Fire Department that responds to this building.
Required in all Fire Plans.

Number of Stories
Number of stories for this building.
Rounded up to nearest integer.
Required in all Fire Plans.

Emergency Exits
Number and location of emergency exits and stairwells.
Triggered by Building Type and Number of Stories.
Location information entered for each exit.
Access information about locks and keys, etc. for each exit.
Conditional requirement.

Elevators
Number and location of elevators.
Special instructions for Emergency Personnel.
Triggered by User Question.
Included in Fire Plan if in existence.
Included in Testing Schedule if in existence.
Included in Maintenance Schedule if in existence.

Fire Access Routes
Location and information.
Required in all Fire Plans.

Siamese Connections
Number and Locations.
Triggered by User Question.
Included in Fire Plan if in existence.

Fire Alarm System
Location, Type and Information.
Triggered by User Question.
Type includes number of phases.
Included in Fire Plan if in existence.
Included in Testing Schedule if in existence.
Included in Maintenance Schedule if in existence.

Voice Systems
Location and instructions.
Triggered by User Question.
Included in Fire Plan if in existence.
Included in Testing Schedule if in existence.
Included in Maintenance Schedule if in existence.

Smoke Controls
Locations, Types, and Information.
Triggered by User Question.
Included in Fire Plan if in existence.
Included in Testing Schedule if in existence.
Included in Maintenance Schedule if in existence.

Sprinklers
Locations and Information.
Triggered by User Question.
Included in Fire Plan if in existence.
Included in Testing Schedule if in existence.
Included in Maintenance Schedule if in existence.

Standpipe and Hose
Locations and Information.
Triggered by User Question.
Included in Fire Plan if in existence.
Included in Testing Schedule if in existence.
Included in Maintenance Schedule if in existence.

Fire Pump
Location and Information.
Triggered by User Question.
Included in Fire Plan if in existence.
Included in Testing Schedule if in existence.
Included in Maintenance Schedule if in existence.

Emergency Power
Location and Information.
Triggered by User Question.
Included in Fire Plan if in existence.
Included in Testing Schedule if in existence.
Included in Maintenance Schedule if in existence.

Fire Extinguishers
Locations and Information.
Triggered by User Question.
Included in Fire Plan if in existence.
Included in Testing Schedule if in existence.
Included in Maintenance Schedule if in existence.

Human Resources

Human Resources will contain information about the people responsible for the building. This section will be broken into the following sub components:

Building Owner
Contact information for person or corporation that owns and is responsible for building liability.
Required in all Fire Plans.

Maintenance
Contact information for person or corporation that is responsible for building maintenance.
Triggered by Building Type.
Triggered by User Question.
May be same as Building Owner.
Included in Fire Plan if applicable.

Security
Contact information for person or corporation that is responsible for building security.
Triggered by User Question.
May be same as Building Owner.
Included in Fire Plan if applicable.

Superintendent
Contact information for person empowered as building superintendent.
Triggered by User Question.
May be same as Building Owner.
Included in Fire Plan if applicable.

Assistant Superintendent
Contact information for person empowered as building assistant superintendent.
Triggered by User Question.
Included in Fire Plan if applicable.

Emergency Procedures

This section outlines actions to be taken by occupants in the event of an Emergency situation. This section is required in all Fire Plans. This section will contain several optional items:

Elevators
To be included if in existence.

Fire Alarms
To be included if in existence.
Detailed message about type of alarms and actions to take.

Emergency Exits
Detailed locations and instructions.

Voice Systems
To be included if in existence.
Instructions about hearing messages.

Fire Extinguishment, Control and Confinement

This section provides instructions about fire discovery, and appropriate containment measures. This section is required in all Fire Plans.

Fire Hazards

This section contains general instructions and guidelines about avoiding Fire hazards. This section is required in all Fire Plans.

Supervisory Staff and Related Duties

This section contains information about specific duties of individuals in the event of an emergency situation. This section will contain different information based on Building Types. This section will be based on multiple templates, each targeting a different Building Type.

Supervisory Staff Training

This section contains specific requirements and instructions regarding training supervisory staff. This section will contain specific information based on Building Type and will be based on multiple templates triggered by Building Type.

Fire Drills

This section contains general information about required Fire Drills. Special instructions may be added or included to specify frequency, record keeping and reporting.

Maintenance Procedures for Fire Systems

This section will begin with general compliance instructions.

This section will contain the following optional items:

Fire Department Access
Required in all Fire Plans.
Period set by Fire Department.

Fire Alarm Systems
Included if exists.
Period set by Fire Department.

Voice Systems
Included if exists.
Period set by Fire Department.

Standpipe and Hose Systems
Included if exists.
Period set by Fire Department.

Portable Fire Extinguishers
Included if exists.
Period set by Fire Department.

Sprinklers
Included if exists.
Period set by Fire Department.

Water Supplies for Fire Fighting
Included if Fire Pump exists.
Period set by Fire Department.

Fire Pumps
Included if exists.
Period set by Fire Department.

Emergency Power Systems
Included if exists.
Period set by Fire Department.

Means of Egress
Included in all Fire Plans.
Period set by Fire Department.

Smoke Control Systems
Included if exists.
Period set by Fire Department.

Service Equipment, Ducting, and Chimneys
Included in all Fire Plans.
Period set by Fire Department.

Alternative Measures for Occupant Safety

This section contains information and instructions regarding the scheduled shutdown and maintenance of required Fire Systems. This section will be building type specific and will be based on multiple templates triggered by Building Type.

Fire Protection Measures

This section is a summary containing brief descriptions and information about the Fire Systems contained in the building.

The section will consist of a standard introduction followed by items that are contained in the building. The items will be triggered by inclusion in previous sections.

The potential included items are:

Fire Department Access
Included in all Fire Plans.

Fire Alarm Systems
Included if exists.

Emergency Exits
Included in all Fire Plans.

Portable Fire Extinguishers
Included if exists.

Standpipe and Hose Systems
Included if exists.

Automatic Sprinkler Systems
Included if exists.

Water Supply
Included if Fire Pump exists.

Fire Pumps
Included if exists.

Emergency Power
Included if exists.

Emergency Lighting
Included if exists.

Elevators
Included if exists.

Schematics

This section contains general information about the required drawings and schematics that are requirements of the Fire Plan. All submitted drawings will be included in this section.

Non-Ambulatory Occupants

This section contains a list of all occupants who require special attention during an emergency situation. This section is triggered by items entered by user. Each item will contain location and specific instructions about the occupant.

Content Triggers

The Fire Plan is specific to a building. Each building has many different attributes. These attributes will determine which sections and sub sections or items are included in the Fire Plan.

Building Attributes

The attributes of a building will be defined below. Each major attribute may contain several items or sub-attributes.

Building Type
Physical Location (Municipal Address)
Physical Characteristics
   Number of Stories
   Number of Suites
   Number of Occupants
   Number of Non Ambulatory Occupants
Emergency Access
   Fire Vehicle Access Route
   Emergency Exits
   Elevators
Emergency Equipment
   Siamese Connections
   Fire Alarm System
   Voice System
   Fire Pump
   Emergency Power
Prevention Equipment
   Smoke Control Systems
   Sprinkler Systems
   Standpipe and Hose Systems
   Fire Extinguishers

Each building also consists of related Human or people attributes. These attributes are listed as follows:
Building Owner
Building Maintenance
Building Security
Building Superintendent
Building Assistant Superintendent

Trigger Questions

Each attribute should be included by default (required) or be triggered for inclusion by the answer provided to a question.

TABLE 5
Trigger Questions

| | | Included in Fire Plan | | | |
|---|---|---|---|---|---|
| Attribute | Question | Residential | Commercial | Industrial | Institutional |
| # Stories | How many Stories? | • | • | • | • |
| # Suites | How many Suites? | • | • | | • |
| # Occupants | How many Occupants? | • | • | • | • |
| # NA Occ. | How many Non Ambulatory Occupants? | • | • | | • |
| Emerg Exits | How many Emergency Exits? | • | • | • | • |
| Elevators | Are there elevators? | • | • | | • |
| Siamese | Are there Siamese Connections? | • | • | • | • |
| Fire Alarm | What type of Fire Alarm? | • | • | • | • |
| Voice System | Do you have a Voice System? | • | • | • | • |
| Fire Pump | Do you have a Fire Pump? | • | • | • | • |
| Emerg Power | Do you have Emergency Power? | • | • | • | • |
| Smoke | Do you have Smoke Control Systems? | • | • | • | • |
| Sprinklers | Do you have Sprinklers? | • | • | • | • |
| Standpipe | Do you have a Standpipe? | • | • | • | • |
| Extinguishers | Do you have Fire Extinguishers? | • | • | • | • |
| Owner | Who is the Building Owner? | • | • | • | • |
| Maintenance | Who is Building Maintenance? | • | • | • | • |
| Security | Who is building Security? | • | • | • | • |
| Superintendent | Who is Building Superintendent? | • | • | | |
| Ass. Super | Who is Building Assistant Superintendent? | • | • | | |

Automatic Triggers

Building Types may automatically trigger required components or items.

TABLE 6
Automatic Triggers

| | Required in Fire Plan | | | |
|---|---|---|---|---|
| Attribute | Residential | Commercial | Industrial | Institutional |
| # Stories | • | • | • | • |
| # Suites | • | • | | • |
| # Occupants | • | • | • | • |
| # NA Occ. | • | • | | • |
| Emerg Exits | • | • | • | • |
| Elevators | | | | |
| Siamese | | • | • | • |
| Fire Alarm | • | • | • | • |
| Voice System | | | | |
| Fire Pump | | | • | • |
| Emerg Power | | | • | • |
| Smoke | | | | • |
| Sprinklers | | | • | • |
| Standpipe | | | | |
| Extinguishers | • | • | • | • |
| Owner | • | • | • | • |
| Maintenance | | | • | • |
| Security | | | | |
| Superintendent | • | | | |
| Ass. Super | | | | |

Building Definitions

Group A—Commercial Recreational
Group A, Division 1 occupancy: Motion picture theatres, Opera houses, Television studios admitting a viewing audience and Theatres including experimental theatres.
Group A, Division 2 occupancy: Art galleries, Auditoria, Bowling alleys, Churches and similar places of worship, Clubs non-residential, Community halls, Courtrooms, Dance halls, Exhibition halls (other than classified in Group E Occupancies), Gymnasia, Lecture halls, Libraries, Licensed beverage establishments, Museums, Passenger stations and depots, Recreational piers, Restaurants, Undertaking premises and Schools and colleges non-residential.
Group A, Division 3 occupancy: Arenas, Indoor swimming pools with or without spectator seating and Rinks.
Group A, Division 4 occupancy: Amusement park structures (not elsewhere classified), Bleachers, Grandstands, Reviewing stands and Stadia.

Group B—Institutional
Group B, Division 1 occupancy: Jails, Penitentiaries, Police stations with detention quarters, Prisons, Reformatories with detention quarters and Psychiatric hospitals with detention quarters.
Group B, Division 2 occupancy: Children's custodial homes, Convalescent homes, Hospitals, Infirmaries, Nursing homes, Orphanages, Psychiatric hospitals without detention quarters, Reformatories without detention quarters and Sanitoria without detention quarters.

Group C—Residential
Group C occupancy: Apartments, Boarding houses, Clubs Residential, Colleges Residential, Convents, Dormitories, Hotels, Houses, Lodgings houses, Monasteries, Motels and Schools Residential.

Group D—Commercial Service
Group D occupancy: Banks, Barber and Hairdressing shops, Beauty offices, Laundries self service, Medical offices, Dry cleaning establishments self-service not using flammable or explosive solvents or cleaners, Offices, Police stations without detention quarters, Radio stations, Small tool and appliance rental and service establishments.

Group E—Commercial Retail
Group E occupancy: Department stores, Exhibition halls, Markets, Shops, Stores and Supermarkets.

Group F—Industrial
Group F, Division 1 occupancy: Bulk plants for flammable liquids, Bulk storage warehouses for hazardous substances, Distilleries, Cereal Mills, Chemical manufacturing or processing plants, Dry cleaning plants, Feed mills, Flour mills, Grain elevators, Lacquer factories, Mattress factories, Paint Varnish and pyroxylin product factories, Rubber processing plants, Spray painting operations and Waste paper processing plants.
Group F, Division 2 occupancy: Aircraft hangers, Box factories, Candy plants, Cold storage plants, Electrical substations, Dry cleaning establishments not using flammable or explosive solvents or cleaners, Factories, Freight depots, Helicopter landing areas on roofs, Laboratories, Laundries except self-service, Mattress factories, Planning mills, Printing plants, Repair garages, Salesrooms, Workshops, Television studios not admitting a viewing audience, Warehouse, Wholesale rooms and Woodworking factories.
Group F, Division 3 occupancy: Creameries, Factories, Laboratories, Power plants, Salesrooms, Sample display rooms, Workshops, Storage garages including open air parking garages, Storage rooms and Warehouses.

Fire Plan Wizard

The purpose of the Fire Plan Wizard (FPW) is to guide a user through the collection of information required to produce a comprehensive Fire Plan. The FPW is able to anticipate the answers to questions from the user and to perform in the same manner as if the user had a consultant sitting beside them guiding the writing of the Fire Safety Plan.

The wizard guides the user from page to page by, preventing them from jumping around and missing important pieces of the data collection process. The FPW remembers every choice the user makes and plots the user's course of action according to the choices and information provided as the user progresses through the pages.

The FPW allows the user to back up and change choices. When this happens new courses may be plotted for the user. The FPW is an interactive tool to customize each user's experience. The FPW displays pages to the user in a controlled window that has almost all normal browser features disabled. There are no buttons or menus for the user to play with, and instead each page displayed by the FPW is generally limited to FORWARD, BACK and EXIT buttons.

As the FPW moves the user from page to page, it saves every piece of data and user choice to the database. If a user exits the FPW halfway through and then returns at a later time, the FPW will remember all of the user's previous choices and the user may now resume from where they left off. The user is therefore not committed to entering all their data in one sitting. Further, if the user gets to a page and does not know the right answer, they may skip that page and return at a later date. No harm is done; if the user plots out a new course, the user simply follows the new course providing further data until they meet up with a page where they have already provided information.

The FPW utilizes a series of progressive dynamic pages that ask the user a series of questions. The next page will be determined by the answer of a question on the previous page. In this respect the wizard will appear to be “intelligent” and help guide the user through the process of collecting relevant information.

The FPW minimizes the amount of typing or data entry the user has to provide by populating most input boxes with typical anticipated responses. The user may then edit the response to more accurately reflect his/her actual situation. The FPW will always save the contents of a page to the database before moving on to the next or previous page. This will ensure that a user never loses his/her work. The FPW will not require any fields on any pages to be completed before allowing the next page to be displayed. Instead of boxing the user in, the FPW will send a reminder to the user's message board to indicate that a page still requires attention before the Fire Plan can be generated. The FPW will provide roll over fly outs (text boxes that magically appear when the mouse passes over a key word) to explain non-obvious concepts and provide short explanations of industry specific monikers. Concepts and or information that requires more in depth explanations will be accessed by providing key word links to help files.

The FPW gathers information based on sections including Information, Human Resources, Building Resources, and Non-Ambulatory Occupants. The Human Resources and Building Resources will always be gathered. The Non-Ambulatory Occupants section will only apply to “Residential” type of buildings.

The first criterion that is required is a unique user identity. This information will include User Name, Home Phone, Work Phone, Pager Number, Cell Number, and Email Address. The registration process will provide this information.

The second criterion that is required is a unique building identity. This information will include Building Name (Owner created), unique Civic Address (including unit or building number), approximate floor area specified by a selectable range criteria. The registration process will provide this information.

The FPW will begin by displaying an instructional page that outlines features of the FPW and its basic operating concepts and criteria. A sample page may be included as a screen shot to help clarify the operation and process flow. The Information Page will contain a check box so that a user may opt not to have the information page displayed the next time the wizard is started. A setting in the user's profile will allow for this feature to be turned back on.

FIG. 4 illustrates a Human Resources (HR) section that begins the intelligent gathering of information process. The HR section will gather information including Legal Owner of the Building, Building Manager, Onsite Manager, Onsite Fire Officer (OFO), Assistant Fire Officers (AFO). The HR pages will begin by asking a series of Yes/No type questions and requesting information about specific key people.

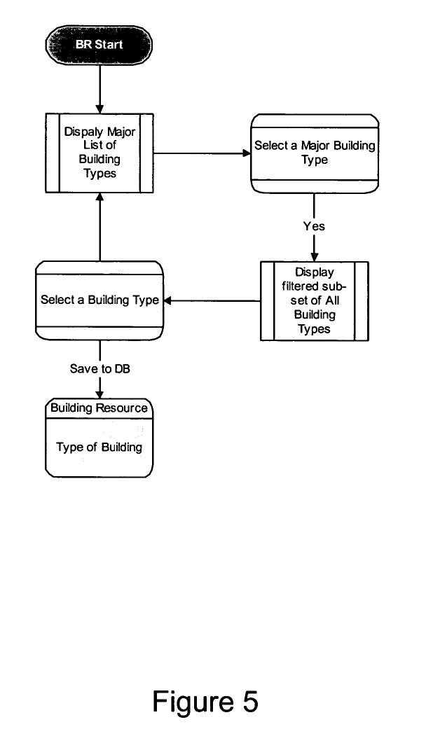

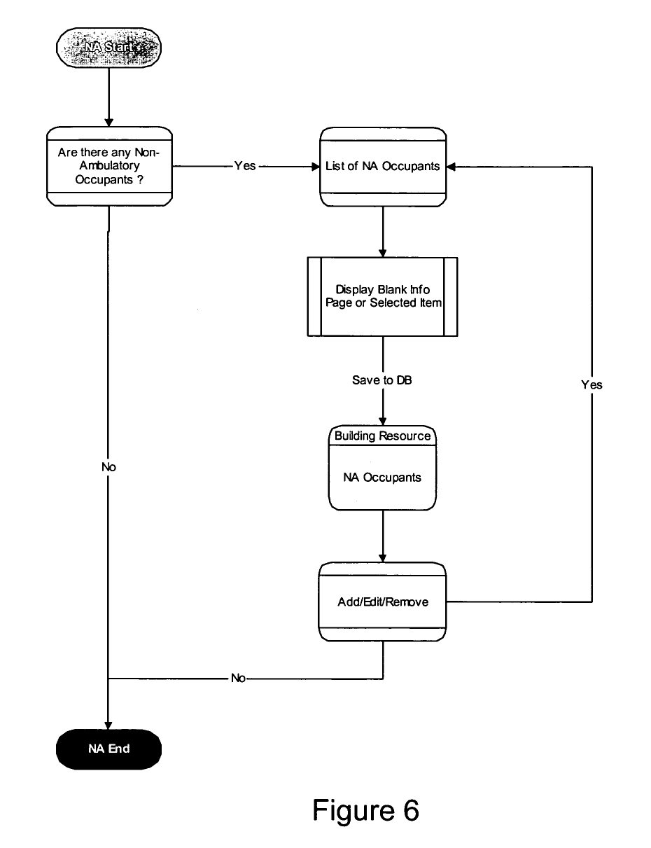

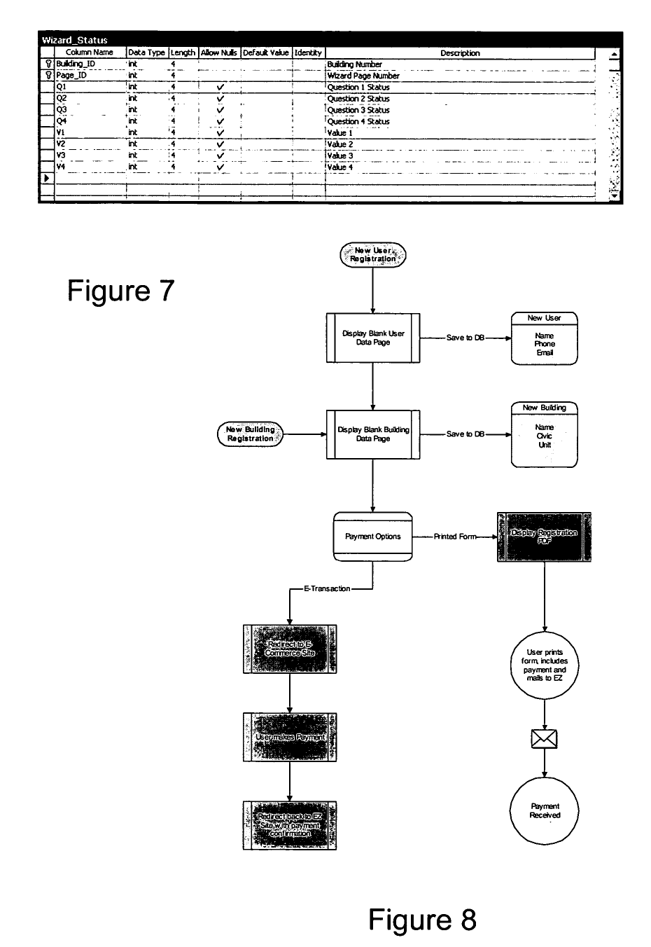

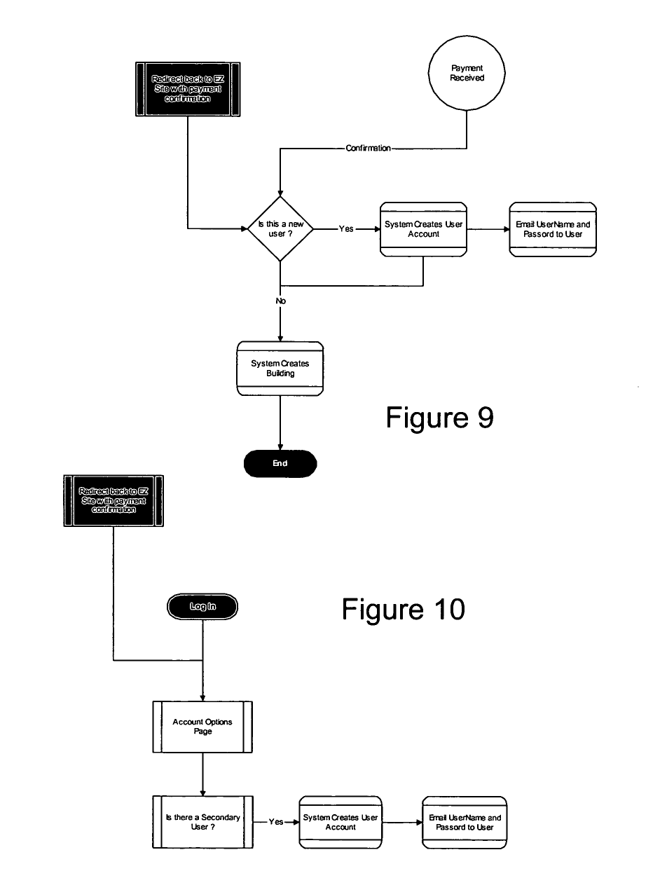

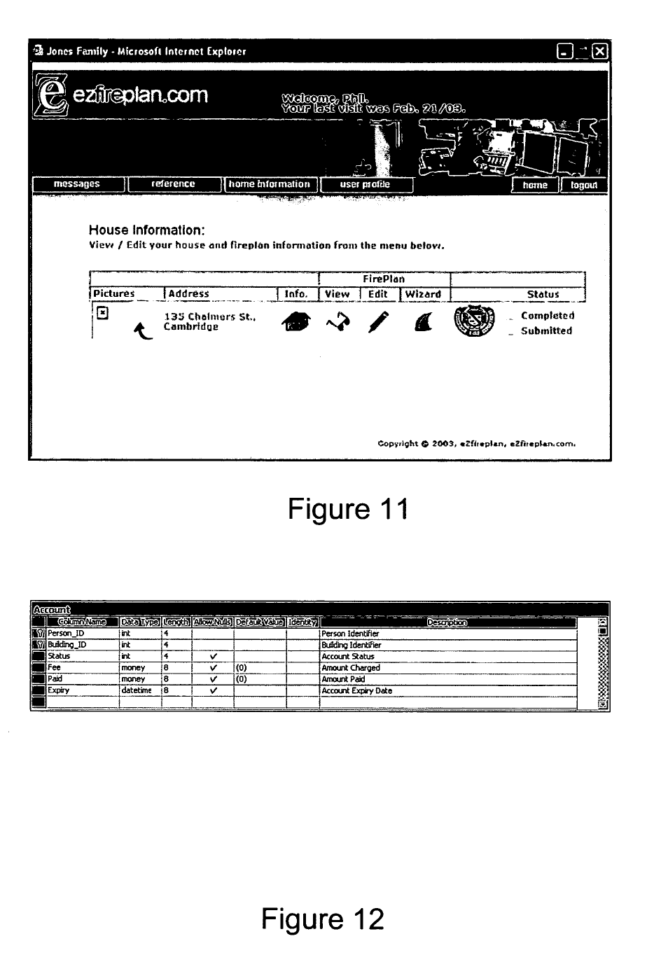

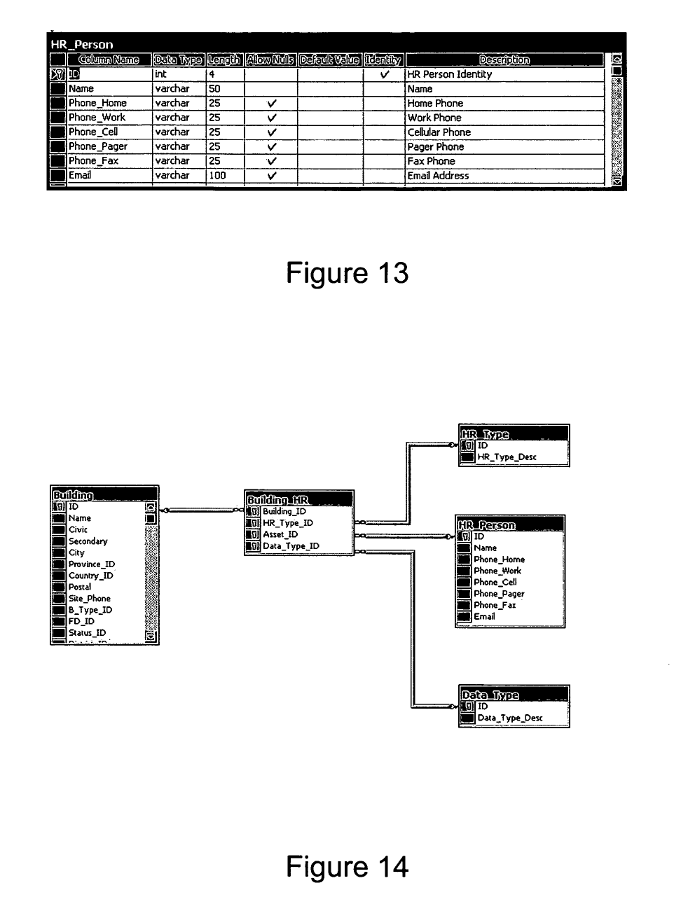

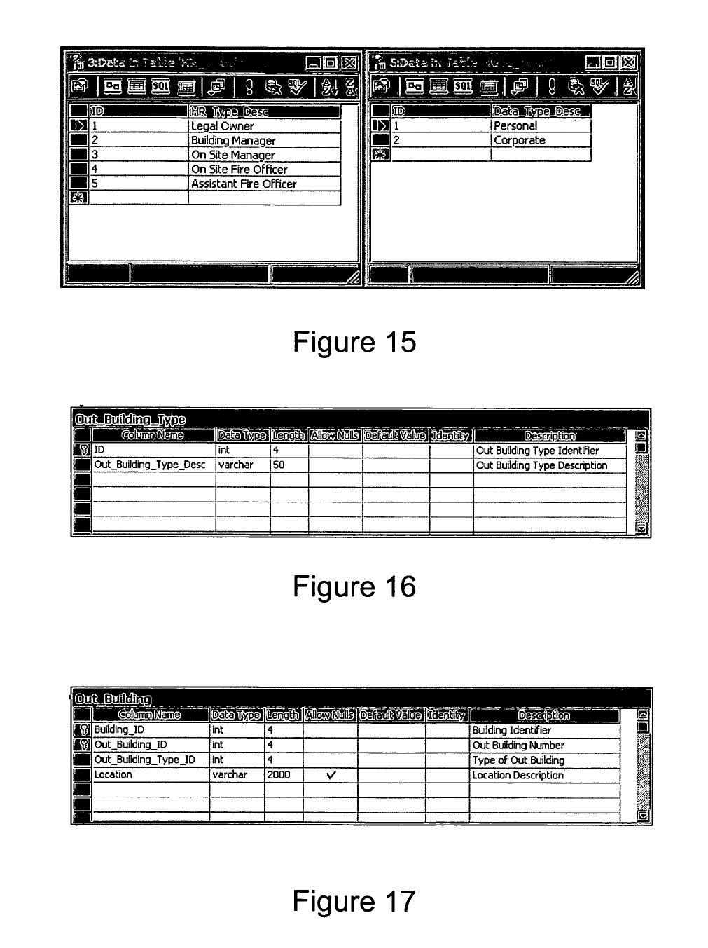

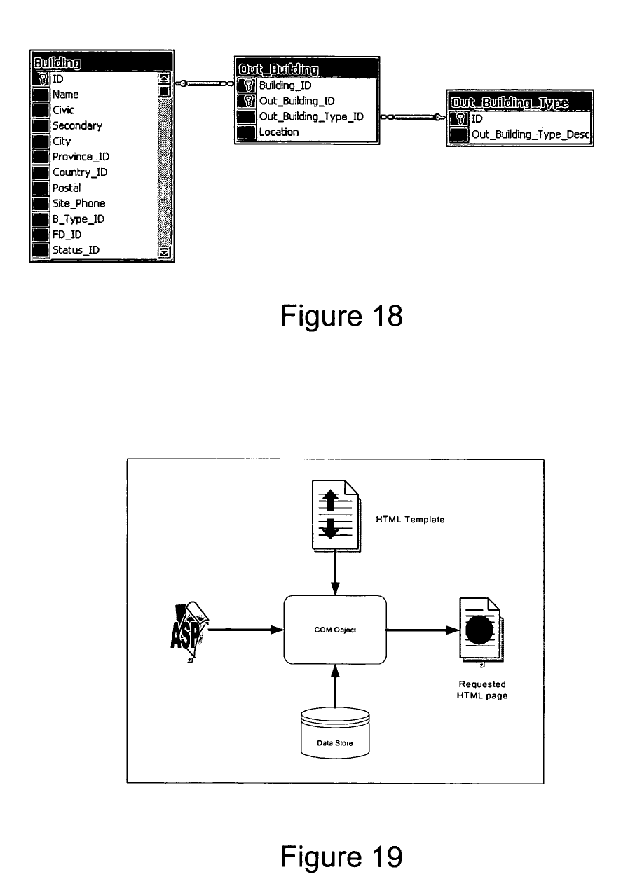

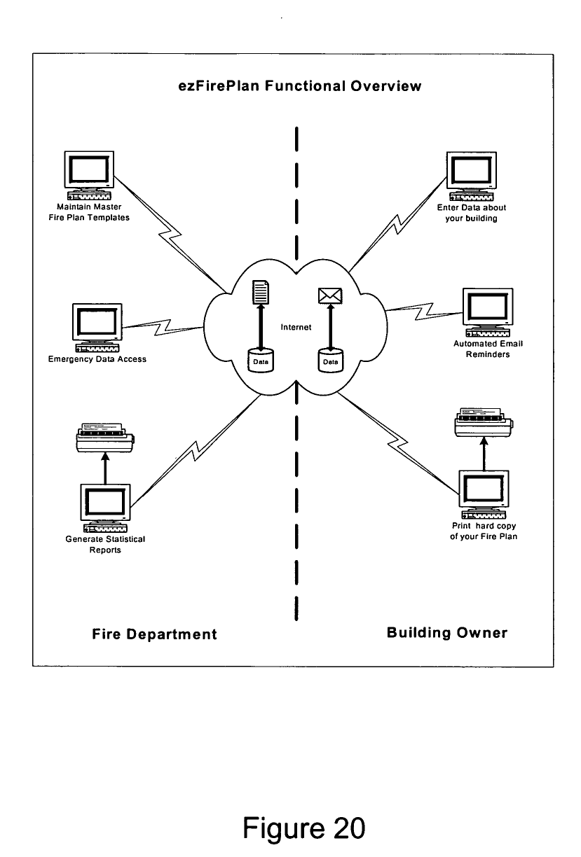

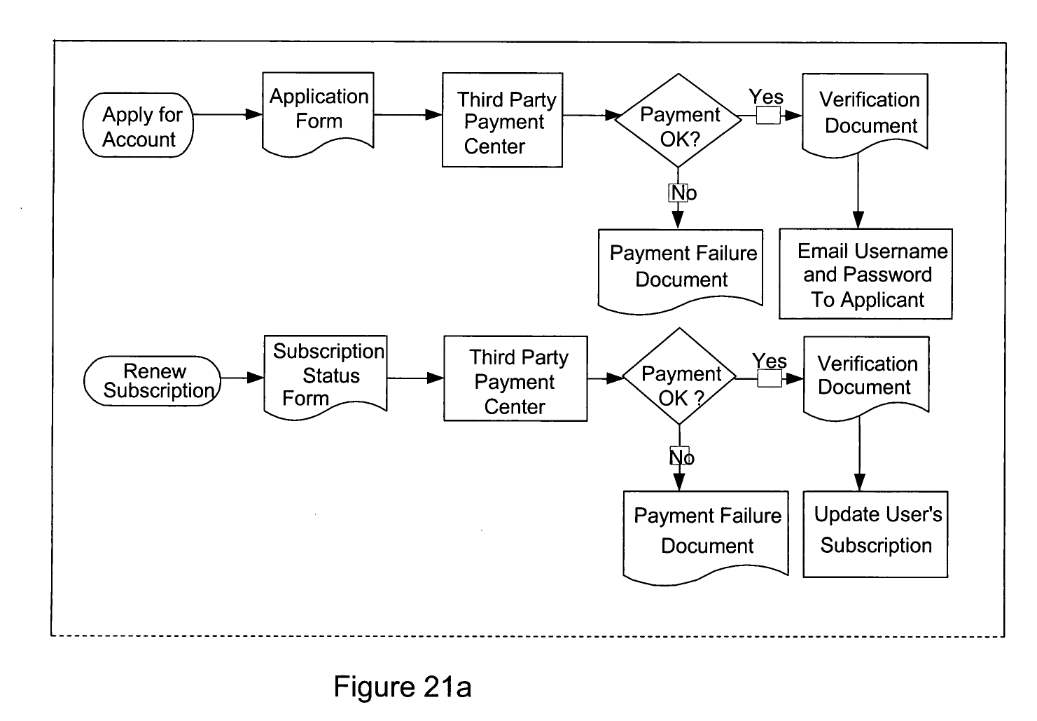

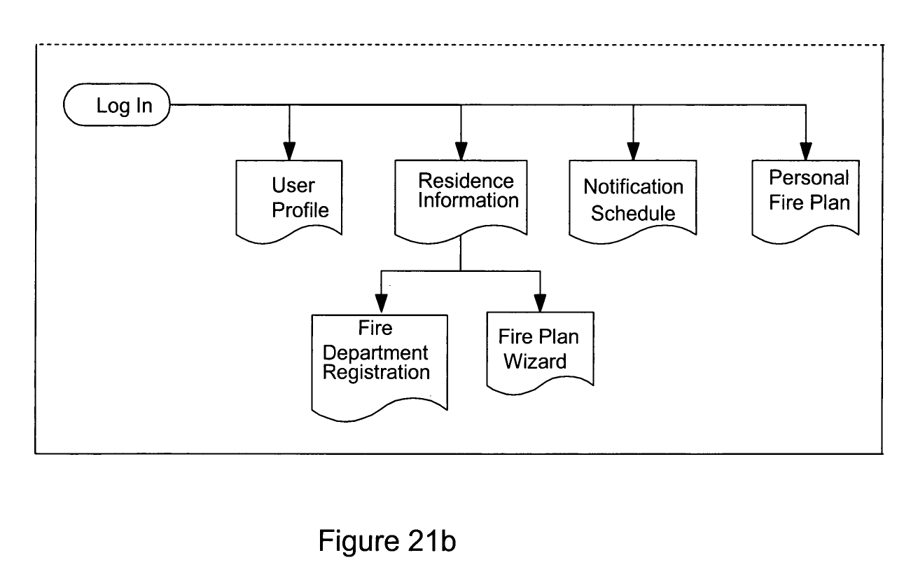

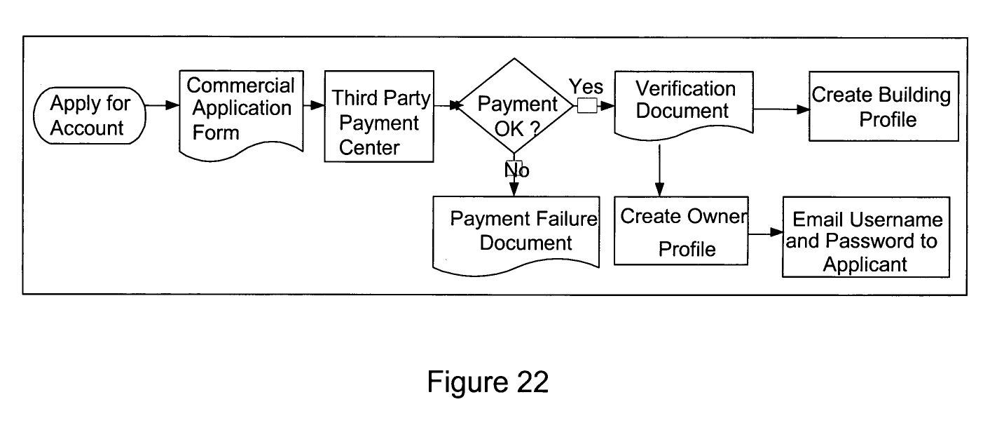

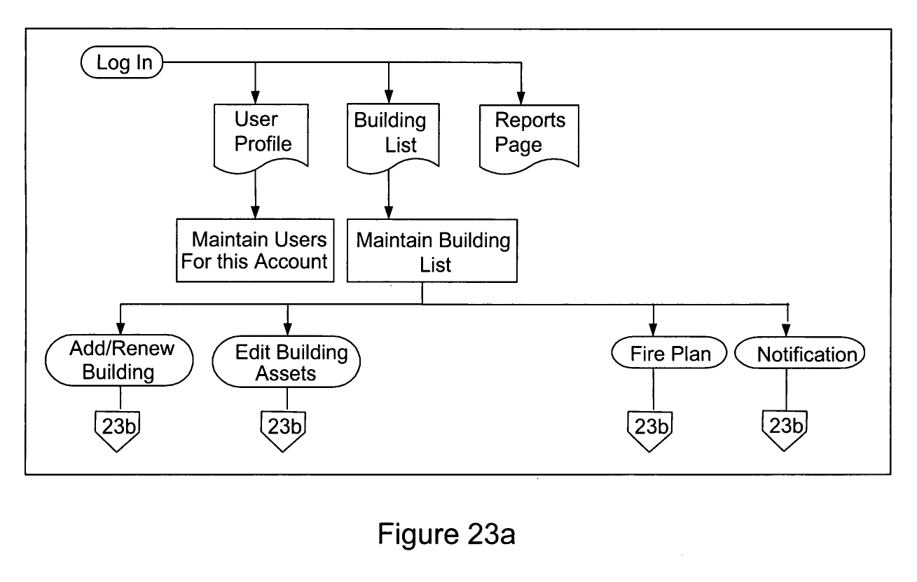

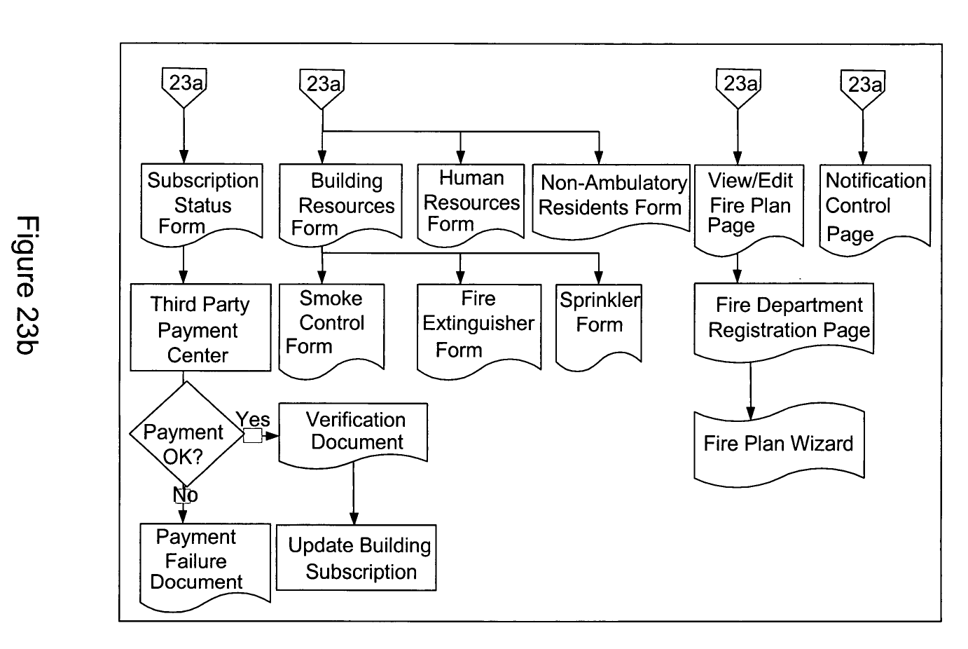

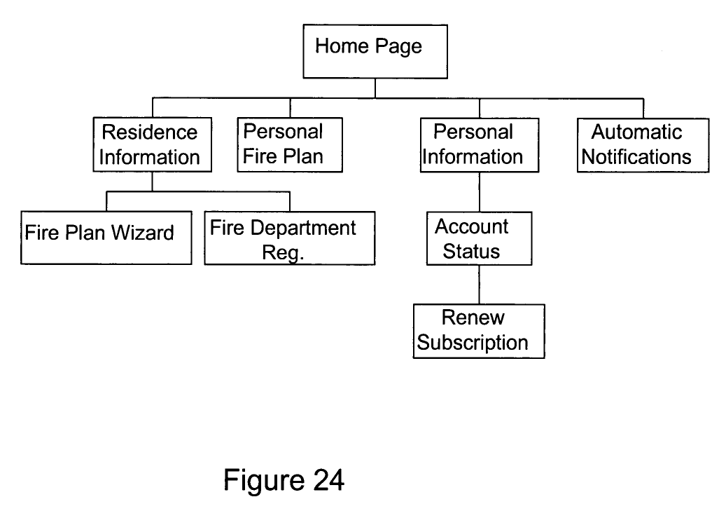

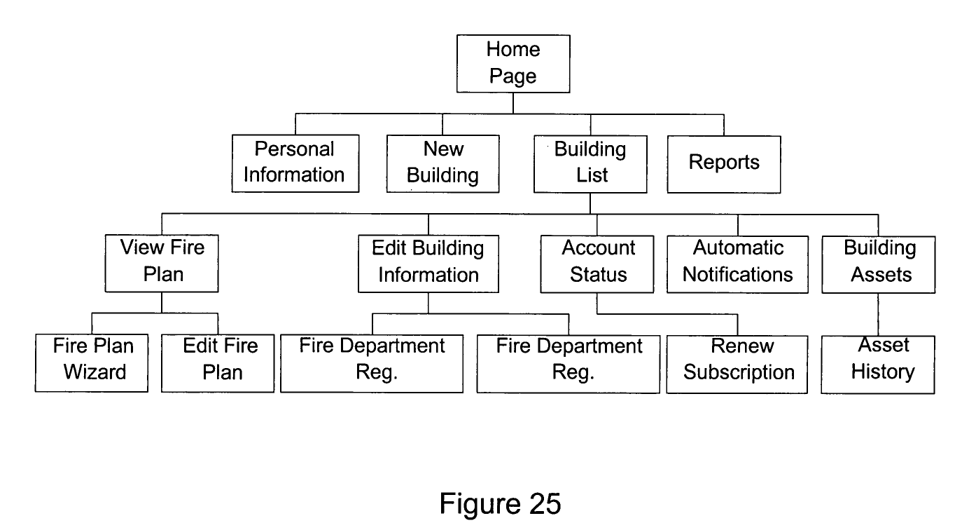

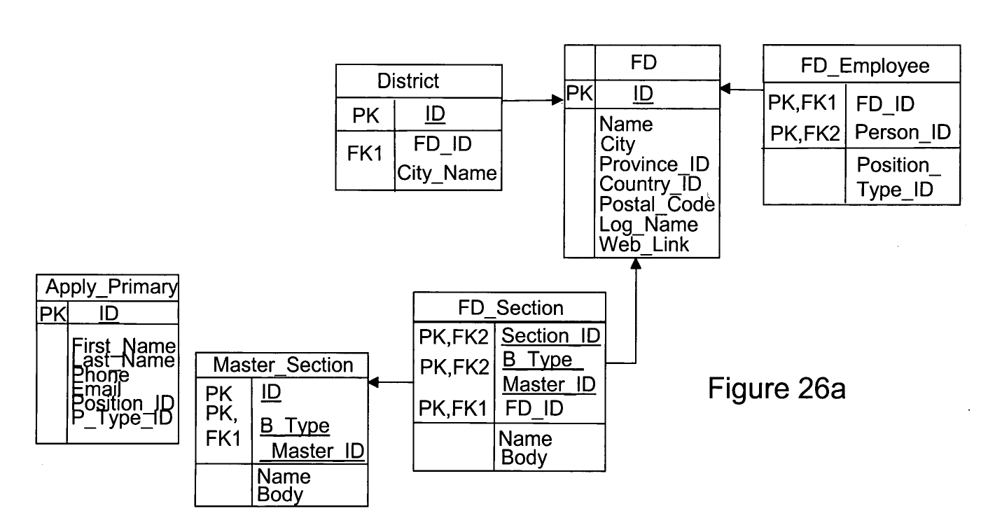

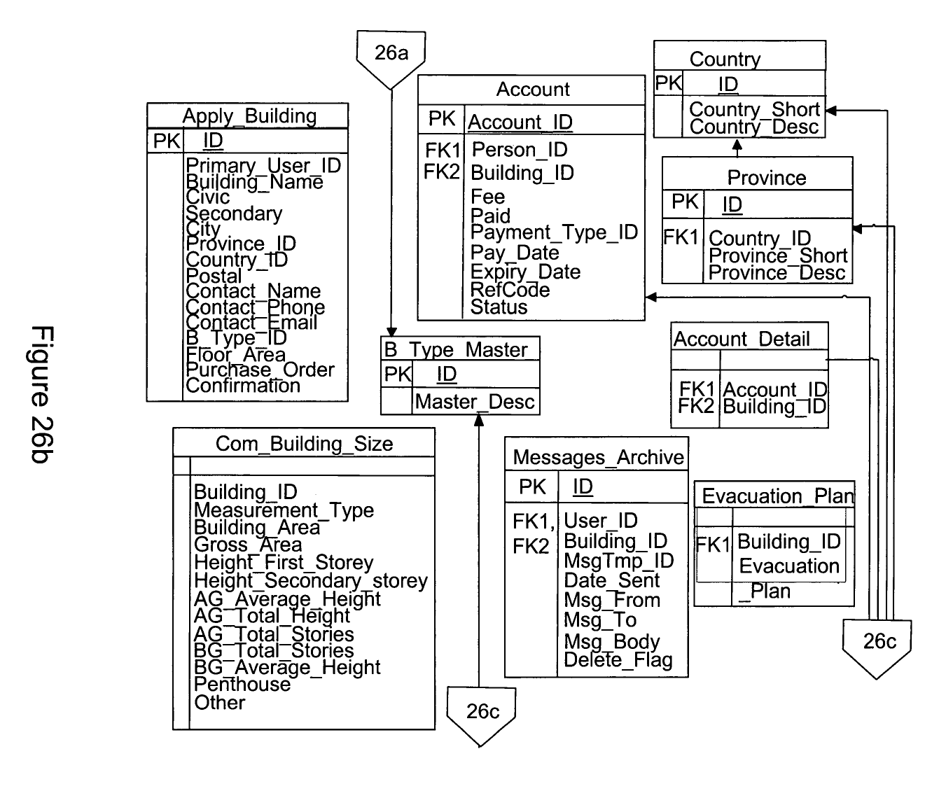

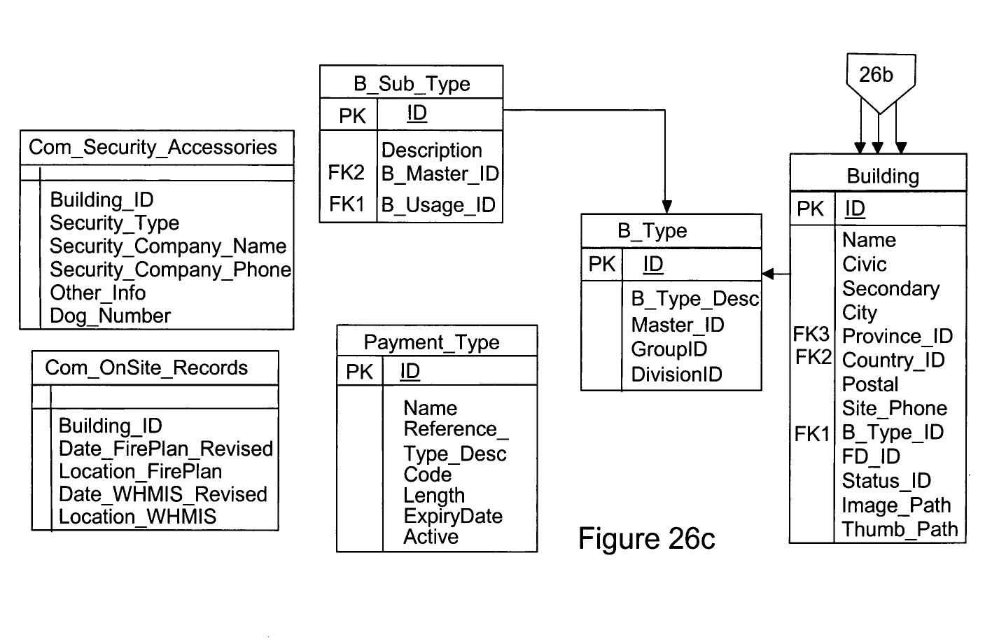

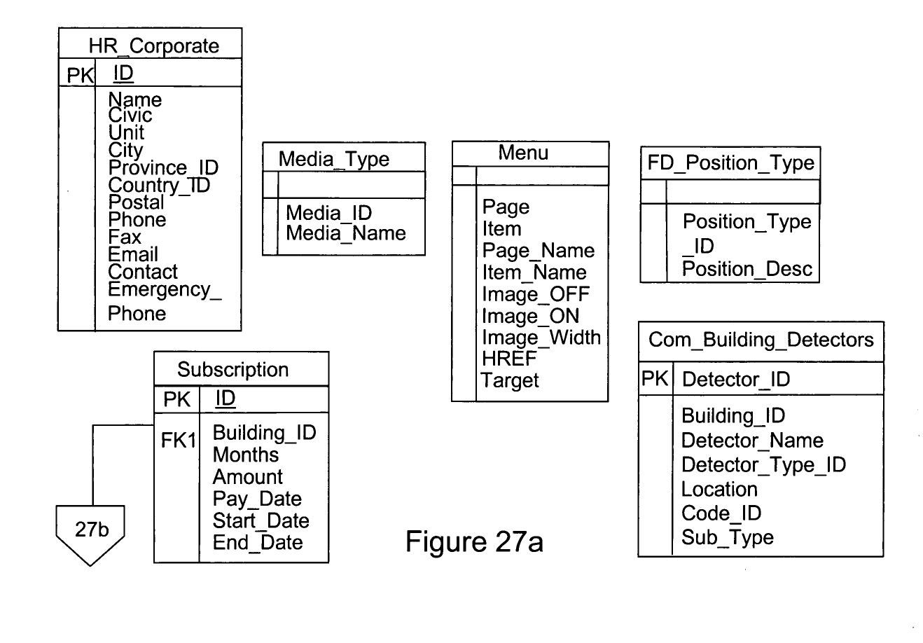

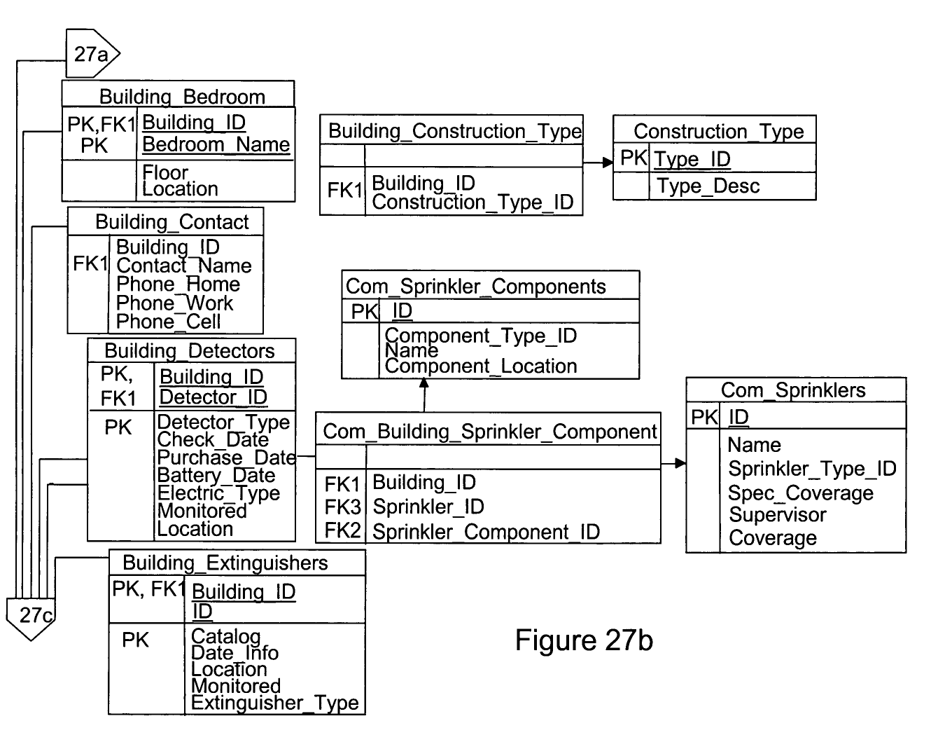

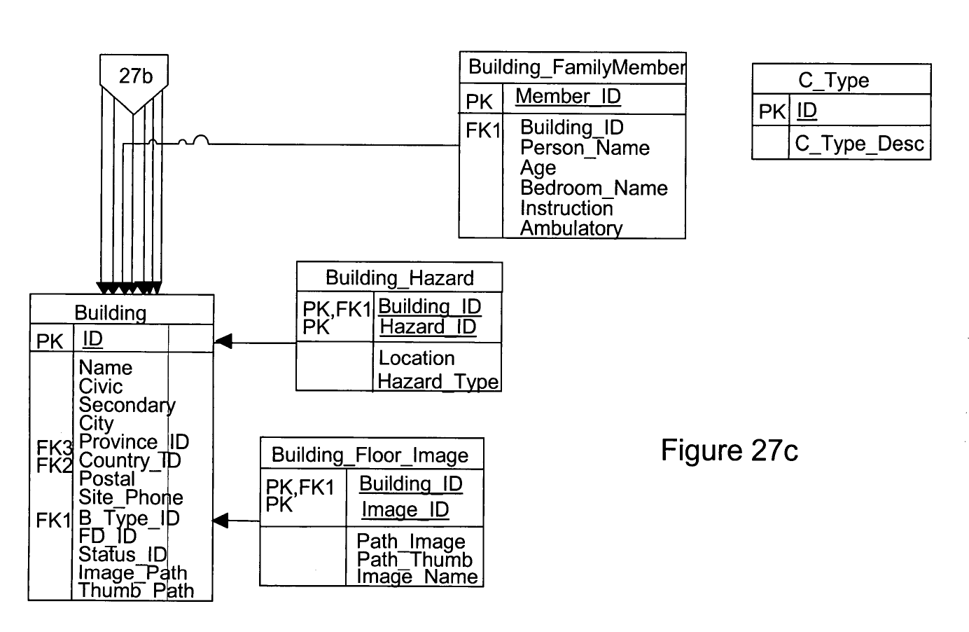

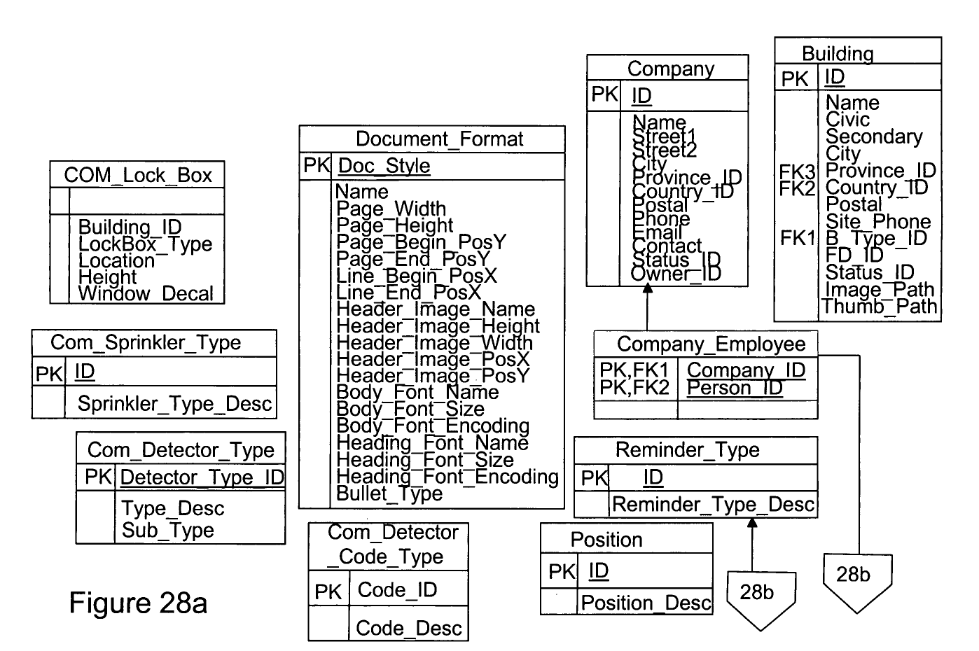

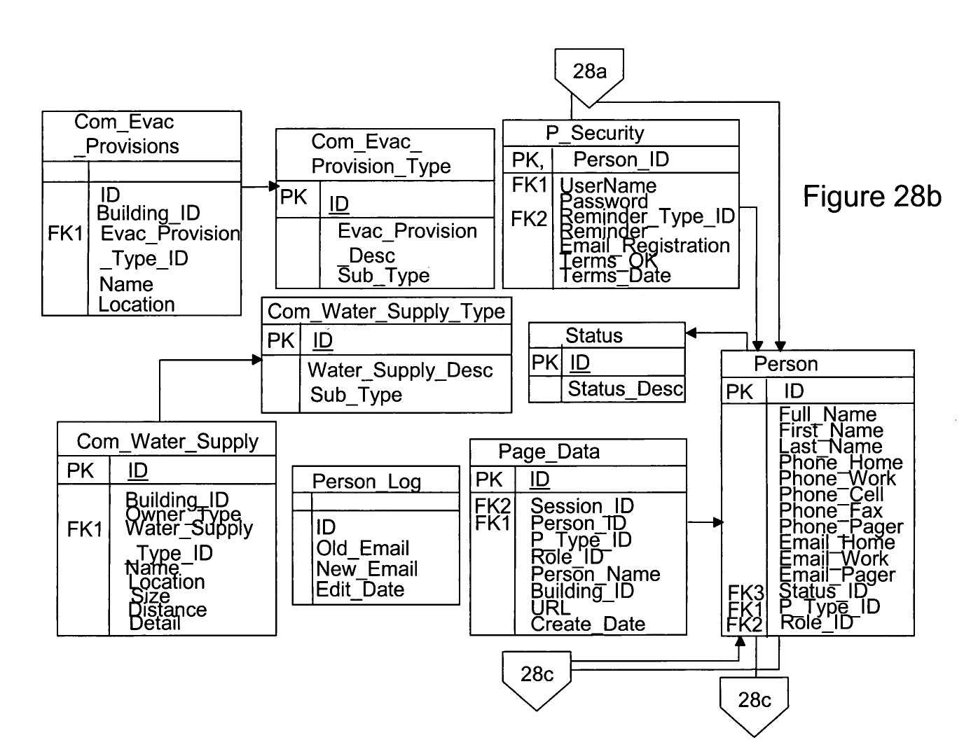

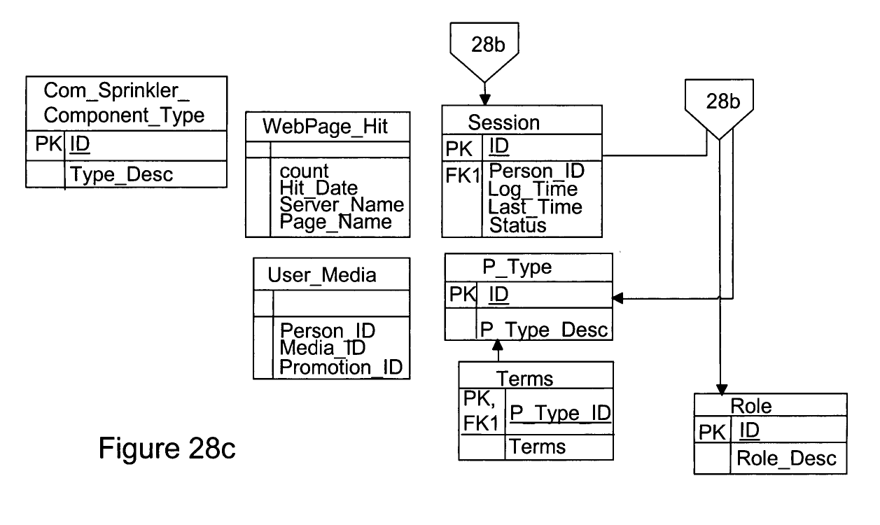

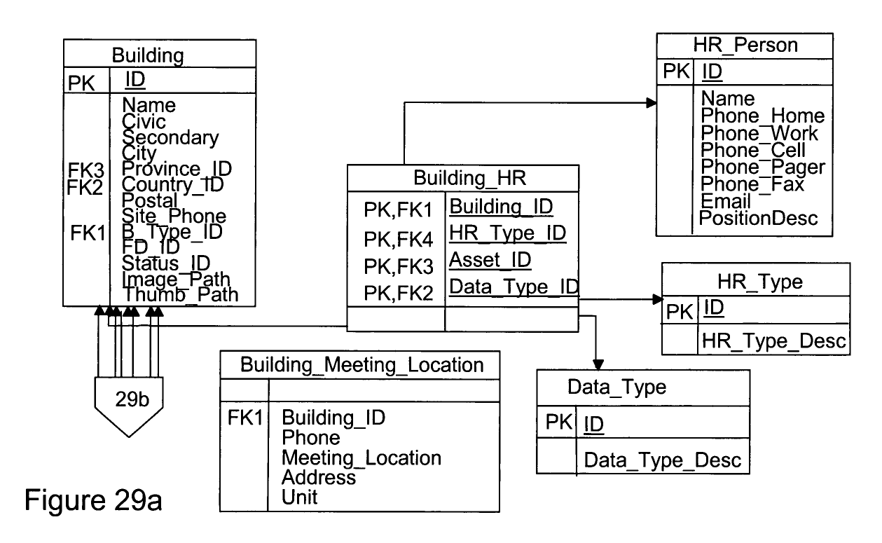

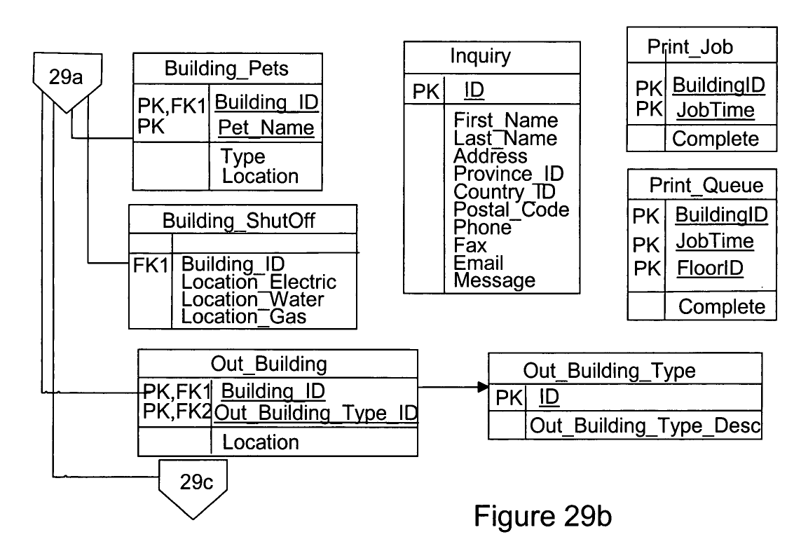

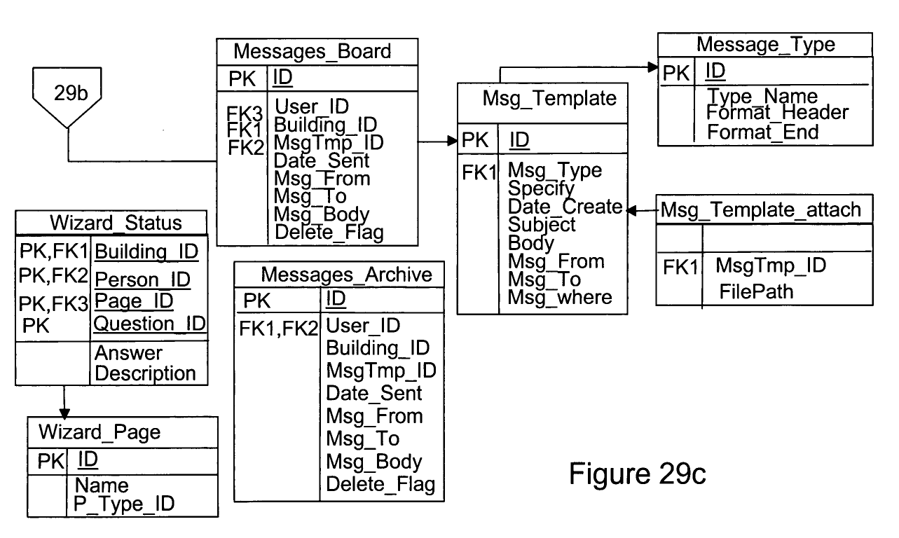

FIG. 5 illustrates a Building Resources (BR) section that guides the user through the gathering of information specific to the physical building. It will gather blocks of information including Type and Size of Building, Building Entrances, Fire Extinguishers, Fire Alarm Systems, Service Providers, Sprinkler Systems, Elevators, Outside Services, Water Resources. The BR pages will begin by asking a series of questions and requesting information about the type and size of building.

The collection of locations such as Building Entrances will utilize a pre-populated or suggested format of user data. An example of such would be the automatic insertion of the words “is located in the center of the East facing wall in the North East corner of the building” in the Location Box for a Building Entrance. The user may then simply edit or change this sentence to more accurately reflect his/her specific building. The automatic population of information gives the user a more confident feeling about the format of data entry.

The system 10 also makes use of the Entrance List to pre-populate other items such as the Fire Alarm Annunciator Panel Locations. They are typically located near a door.

The collection of Fire Extinguisher information will also allow us to capture the Building's Service Provider, if there is one. This information will also be used to pre-populate further information boxes.

Non-Ambulatory Occupants

The Non Ambulatory Occupants section will be included if the building contains any Residential Occupancy. It will gather specific information about individuals that are challenged in any way with regards to evacuating the building.

The following pages will outline the intelligent functionality designed into the wizard. The user will be guided to new pages based on his/her answers from previous pages. This will help streamline the data collection process.

The wizard will also remember the user's answers to all questions so that when a user revisits the wizard, his/her previous answers will be displayed. This will allow the user to complete the data entry at his/her own pace and even in several different sessions if desired.

The first page in the FPW determines the legal owner of the building. The owner can be the user, another individual, or a Corporation.

The page will contain all of the above items and use JavaScript to manipulate the visibility of each set of components.

When the Next button is pressed, the system 10 will save all relevant information to the database. If the back button of the next page is pressed then this page will load the last saved information from the database, set visibility of all components and display the information to the user with all of the original functionality of the page intact.

To facilitate this type of functionality the system 10 saves the status of the selection buttons as well as two sets of information. If the user enters corporate information and then clicks the No button, the system 10 will display the personal information boxes. If he/she changes his/her mind and clicks the Yes button then the system 10 will redisplay the previous corporate information he/she just entered. This is true even if the user has left the page and then returns.

Registration

The registration process is divided into several types of registration based on building type, usage, etc. The system 10 provides a Registration wizard to guide users down the correct path of registration.

Residential including Single Family, Multi Family (Single Building), Multi Unit (Apartments, etc.). Commercial including Multi Unit residential (Apartments, etc.). As well, Industrial, Institutional, Service Provider, Fire Department, Municipality.

Business Rules

Each residential registration will have an account (Primary User).

Each residential account may have a secondary account (Tennant).

The user who creates the account is the owner or payee of the account.

A single building may have multiple units.

Each unit may have an account.

Each unit may have only one account.

A user may own many accounts.

Each unit shall have one resident login.

Resident Logins should be unique in the system 10.

The Residence should be unique in the system 10.

The Residence is identified by its Civic (municipal) street address plus a unit number if applicable.

Multiple residences that share a common Civic address will be uniquely identified by the Unit Number.

The Building Type will be limited to a Single Family Residence.

As residents of a unit, apartment dwellers may register their individual units.

Owners of multi tenant buildings must register the building as a commercial building and develop an appropriate fire safety plan for the commercial requirements of the building. A single family Residential fire plan is not intended to replace a commercial fire plan, but instead to supplement it.

To allow change in ownership of Houses, see the Ownership Transfer Section below.

Customer must renew his/her subscription (account) once a year.

System 10 notifies Customer 30 days prior to expiry.

System 10 notifies Customer 10 days prior to expiry.

System 10 cancels user log in if account is not renewed prior to expiry.

System 10 notifies customer with cancellation and instructions or a link with info on how to re-activate account.

Information about Residence will remain in the system 10 and be available to Fire Department but will be marked as not up to date.

After a period of six months the system 10 will purge inactive accounts.

There are two scenarios for Transfer:
1. Owner sells the house.
2. Tenants change in a house without ownership change.

In this discussion the owner of the house is the account owner and the tenant is the person living in the house but not the account owner. The owner could also be the tenant.

Scenario One—Owner Sells the House

Owner logs on to site and indicates that he/she is transferring ownership.

Owner will enter information about new residence (civic address, etc.)

System 10 will check the availability of the new residence.

If the new residence is not available (another customer has an active registration) the system 10 will notify the new residence owner that a notice of transfer has been received.

The new residence owner should log in to site and elect to transfer or cancel his/her account.

The system 10 will release the old address on the moving date entered by the owner.

The system 10 will transfer the remaining time of the owners account to the new residence on the moving date if the new owner has released his/her account by canceling or transferring.

The system 10 will allow active accounts without a current residence.

The system 10 will notify the new residence owner if he/she fails to respond prior to the moving date.

The system 10 will continue to notify the new residence owner for 30 days after the moving date if he/she has failed to respond.

After 30 days the system 10 will notify the Transferee that the new residence owner has failed to respond and to please confirm that the address is correct.

When the transferee acknowledges the address the system 10 will mark the new residence owner's account as abandoned and transfer ownership to the transferee.

The new residence owner's account will remain active but will not be associated to the residence in question.

Scenario Two—Owner Keeps House—Tenant Moves

Owner logs on to site and changes username and password for tenant account.

Owner gives new username and password to new tenant.

Registration will be a two part process.

A new user must first create a user account that will allow him/her access to the system 10. This process will start from a DMZ (De-Militarized Zone) and take the user through a series of steps including payment to establish a user account and then automatically add a new building to the account. An existing user may log on to the site and choose to add a new building (or account).

The user may choose to pay using e-commerce or by printing a document and sending it along with a check payable to system 10. When the payment is confirmed, the system 10 will generate a user account (if it is a new user) and a new building in the system 10.

The user may now log in to the web site, or will continue if already logged on, and enter additional information about the building. The Primary User (owner of the account) may add a secondary user to access the system 10. This may be useful if the Primary User is the building owner and is paying for the account but is renting the unit to a tenant and wishes the tenant to enter his/her own information.

If a Secondary User is added the system 10 will notify him/her and provide a user name and password for system 10 access. This completes the Registration/Add new Building process.

Residential Wizard Tech Specs

Each Building must have an Owner.

An Owner may have several Buildings.

Each User will have at least one Building in his/her House Information List. The Account Table will hold the relationship between Users and the Buildings that appear in their House Information List.

Data will be saved in the HR_Person Table.

An entry in the Building_HR Table will link the record in HR_Person to the record in the Building Table.

The HR_Type would be identified as Legal Owner.

The Data_Type would be identified as Personal.

The Building Type Drop Down List will be populated from the B_Type table filtered using the B_Type_Master table for Residential Type Buildings. The users selection will be stored in the Building Table in the B_Type_ID field. If the user selects Yes to the question “Are there any other buildings” the page will display information about Out Buildings. The Type of Building Drop Down List will be populated from the Out_Building_Type tabled.

Online Drawing Tools

Since the user is required to provide a floor plan drawing, the user is provided with an online drawing to ensure a common format. The drawing tool monitors changes made to a user's drawing that are saved as vectored data in the database, renders a new drawing when a change is made, converts the rendered drawing to an image file, then manages the image file directory and makes the correct image available when the server generates the fire plan.

User's can create multiple floors as well as delete floors from their drawings. When a floor is created or edited, its image is updated. When a floor is deleted, its image is deleted. This process happens in real time so that the dynamically generated fire plan always includes the latest floor plans.

User Viewing and Printing

In the Internet environment where the general public is accessing the information, there is no certainty of what type of software the user has available for viewing or printing documents. The system 10 uses a custom object that retrieves each user's data from the database, correctly formats the user's document based on custom templates, and then streams this information to the user's browser without ever actually creating a hard file on the server. This means that the fire plans do not actually exist as a single entity, but are instead created on demand, using the most recent and up to date data supplied by the user and formatted to fit the correct template and maintained under the user's local fire department when the user requests it. All data changes are immediately included in the next document rendering and the document automatically fill the needs of the local fire department, because the fire department is responsible for maintaining the framework templates less, the input data, for their users.

Security

The system 10 uses a secure server having a site security certificate from a trusted provider, providing a high level of encryption commonly used by financial institutions. Secondly, the user is required to login with a username and password for each session. Thirdly, no user information is passed from page to page. Instead, all information is stored in a database by each page and then the next page requests the information from the database. Fourthly, ever page validates the user's session utilizing a customized method of tracking user sessions. Every single page validates the session before displaying any information to the user. If a user is inactive for a period of time and then returns to the computer they will be asked to resubmit their password before proceeding.

Fifthly, every component that is exposed to the Internet utilizes the user's session for validation. This process stops malicious users from accessing system 10 components. The system 10 utilizes virtual directories on the website that contain user information. When a user logs on, a virtual directory is created for the user's session and destroyed when the session ends. This means a user's information is not available on the website unless they are logged on and validated. As well, the web server is set to disallow browsing, so that the only way to access data is by logging on with a valid username and password. In addition, firewalls, virus protection, and routine updates of patches are maintained.

Security Objects

The Security Object's purpose is to validate each user as they log in to the web site. It also checks the status of the user's session every time they request a page. If the session has been dormant for more than ten minutes the web site will ask the user to supply his/her password. This is similar in nature to a password protected screen saver. It helps protect the web site from unauthorized people browsing on an open session.

Every page displayed to the user after the Log In page (with the exception of the Error Display Page) will be protected by the session object.

Each user will be required to supply a valid User Name and Password to gain access to the protected areas of the web site.

Each page will test the session for its status.

The Session will time out after ten minutes and require the user to re-enter his/her password.

Reference

| | |
|---|---|
| Type Library | xSecurity.tlb |
| Interface | lxSecurity |
| Reference | MAD Security Object Type Library |
| CreateObject | xSecurity.clsSecurity |

Functions
PageNumber=obj.LogInUser (UserName, Password)
PageNumber is the Page Number assigned if the user is successful in logging in.
UserName is the User's Log In Name
Password is the User's Password supplied in plain text

This function call validates the Users Name and Password and then creates a new entry in the Session Table for the User. It also creates a new entry in the Page_Data table containing information about the user. The Page Number is passed from page to page so that the system 10 can look up information about the user.
Status=obj. CheckSession (Session, UserID)
Status is the returned value of the call. Valid options are:
   SESSION_OK=0
   SESSION_TIME_OUT=−1
   SESSION_ERROR=−2
Session is the Session Number
UserID is the User Identification Number

This function tests the condition of the session. It is called when a user requests a new page.
Status=obj. RefreshSession (Session, UserID, Password)
Status is the returned value of the call. Valid options are:
   SESSION_ACTIVE=0
   WRONG_USER_NAME=−1
   WRONG_PASSWORD=−2
Session is the Session Number
UserID is the User Identification Number
Password is the user supplied password in plain text

This function is called to re-activate a current session after it has timed out.
LogOutUser (Session, UserID)
Session is the Session Number
UserID is the User Identification Number
A boolean is returned to indicate success

This function is called to terminate a session.

Communities as well as property owners will experience improved levels of fire safety and awareness.

Since the system 10 uses HTML as a wrapper around Basic language, it enable more intelligence and interaction for the user as well as improved speed with the application. The capacity of the computer accessing the application becomes irrelevant because the data being entered is immediately transferred to the application for processing on-line. Intelligent algorithms assemble the data involved and HTML pages are constructed immediately so that the pages appearing on the user's computer screen support the choices made by the user. The system 10 is capable of accommodating a number of language preferences, dynamically so that each set of pages does not need to be re-done.

Because the system 10 is convenient, it will encourage better rates of compliance with existing regulations.

Since the system 10 is not a conventional website such as ASP architecture, it can accommodate up scaling without significant cost and many technical difficulties.

Although the present invention has been described in considerable detail with reference to certain preferred embodiments thereof, other versions are possible. Therefore, the spirit and scope of the appended claims should not be limited to the description of the preferred embodiments contained herein.

1. An online fire plan system comprising:
a data entry, storage and retrieval module having:
a web page layer;
a business layer; and
a data layer; and
a fire plan wizard for guiding a user through said data entry, storage and retrieval.

2. The system according to claim 1, further including a document generator.

3. The system according to claim 1, further including a drawing package to print drawings while data still effectively resides on the server.

4. The system according to claim 1, further including an administrative interface.

5. The system according to claim 1, further including an electronic mail generator.

6. An online fire plan method comprising the steps of:
(i) creating an online fire plan; and
(ii) accessing said fire plan online.

7. An online fire plan system comprising:
a module for creating an online fire plan; and
a module for accessing said fire plan online.

8. A computer program product for implementing an online fire plan method, the computer program product comprising:
a computer readable medium for storing machine-executable instructions for use in the execution in a computer of the method, the method including the steps of:
creating an online fire plan; and
accessing said fire plan online.
